(19) United States
(12) Patent Application Publication
(10) Pub. No.: US 2022/0334243 A1
(43) Pub. Date: Oct. 20, 2022

(54) SYSTEMS AND METHODS FOR DETECTION OF CONCEALED THREATS

(71) Applicant: Massachusetts Institute of Technology, Cambridge, MA (US)

(72) Inventors: Marianne A. DeAngelus, Somerville, MA (US); Justin Goodwin, Lincoln, MA (US); Neela Kaushik, Cambridge, MA (US); Anthony Opipari, Ann Arbor, MI (US); Taylor Killian, Toronto (CA)

(21) Appl. No.: 17/219,837

(22) Filed: Mar. 31, 2021

(51) Int. Cl. G01S 13/89; G06V 10/77; G06V 10/80; G06V 10/82; G01S 13/86

(52) U.S. Cl. CPC G01S 13/89; G06V 10/7715; G06V 10/806; G06V 10/82; G01S 13/867; G06V 2201/05

(57) ABSTRACT

Described herein are systems for detecting a representation of an object in a radio frequency (RF) image. The system transmits one or more first RF signals toward an object, and receives one or more second RF signals, associated with the one or more transmitted RF signals, that have been reflected from the object. The system determines a plurality of first feature maps corresponding to a RF image associated with the one or more second RF signals. The system combines the plurality of first feature maps. The system further detects a representation of the object in the RF image based at least in part on the combined plurality of first feature maps.

### STATEMENT OF GOVERNMENT INTEREST

This invention was made with Government support under Grant No. FA8702-15-D-0001 awarded by the U.S. Air Force. The Government has certain rights in the invention.

### TECHNICAL FIELD

The present disclosure relates to detection of concealed threats in crowded environments. More specifically, the present disclosure relates to methodologies, systems and devices for automatically detecting concealed items carried on an individual's body using a radio frequency (RF) signal. The present disclosure also describes methodologies for classifying concealed item, generating alerts, and creating visualizations of the concealed item.

### BACKGROUND

RF imaging systems are non-ionizing and a cost effective sensing modality for a variety of applications, including Non-Destructive Evaluation (NDE), medical diagnostics, and detection of concealed weapons. RF imaging systems have the ability to help identify a concealed threat, for example, a knife, gun or explosive that is not visible to the naked eye, or cannot be detected by a security or surveillance camera capturing a field of view in which the concealed item is located.

### SUMMARY

Embodiments of the present disclosure include systems and methods for detecting concealed objects carried by a subject in a field of view of a RF imagining system. An example system can include a panel array operable to transmit one or more first RF signals toward an object, and receive one or more second RF signals, associated with the one or more transmitted RF signals, that have been reflected from the object. The example system can include one or more cameras configured to capture one or more images of the object. The one or more cameras can be at least one of red, green, blue (RGB) cameras, or red, green, blue depth (RGB-D) cameras.

The example system can include at least one a processor operable to determine a plurality of first feature maps corresponding to a RF image associated with the one or more second RF signals, combine the plurality of first feature maps, and detect a representation of the object in the RF image based at least in part on the combined plurality of first feature maps. The processor can detect a representation of an individual in the RF image based at least in part on a combination of a plurality of second feature maps corresponding to the RF image associated with the one or more second RF signals. The processor can further determine a number of first feature maps that correspond to the RF image based at least in part on applying one or more first convolutional filters to the RF image. The RF image can include both real and imaginary components, and/or a magnitude and phase component. The one or more first feature maps can be based at least in part on the real and imaginary component, and/or the magnitude and phase component of the RF image.

The processor can combine the first feature maps based at least in part on applying one or more second convolutional filters to the RF image, and then determine the first feature maps based at least in part on inputting the RF image to a convolutional neural network that includes one or more stages.

### BRIEF DESCRIPTION OF THE DRAWINGS

The foregoing and other features and advantages provided by the present disclosure will be more fully understood from the following description of exemplary embodiments when read together with the accompanying drawings, in which:

FIG. 1A illustrates an exemplary imaging sensor system for imaging and detecting concealed objects, in accordance with exemplary embodiments of the present disclosure.

FIG. 1B illustrates a flow diagram of an exemplary process of an imaging sensor system for processing radio frequency (RF) images and color photo images to produce data associated with a concealed item, in accordance with exemplary embodiments of the present disclosure.

FIG. 2 illustrates an exemplary RF imaging sensor of an imaging sensor system embedded in or disposed behind an advertisement display and illuminating a field of view in front of the advertisement display, in accordance with exemplary embodiments of the present disclosure.

FIG. 3 illustrates an arrangement of RF imaging sensors of an imaging sensor system disposed at an entrance of a building in which a field of view of a first RF imaging sensor intersects a second field of view of a second RF imaging sensor, in accordance with exemplary embodiments of the present disclosure.

FIG. 4A illustrates a block diagram of one or more hardware and software modules of an imaging sensor system for transmitting, receiving, and processing one or more RF signals, in accordance with exemplary embodiments of the present disclosure.

FIG. 4B illustrates an exemplary physical arrangement of components of an imaging sensor system comprising RF panel arrays, in accordance with exemplary embodiments of the present disclosure.

FIG. 4C illustrates a RF signal processing system of an imaging sensor system including a data acquisition and processing acquisition system, a computer, and adjunct sensors, in accordance with exemplary embodiments of the present disclosure.

FIG. 5A illustrates an exemplary panel array tile of a panel array in a four panel array system, in accordance with exemplary embodiments of the present disclosure.

FIG. 5B illustrates an exemplary panel array in a four panel array system, in accordance with exemplary embodiments of the present disclosure.

FIG. 6A illustrates an orientation of two panel arrays of an imaging sensor system suspended from a ceiling, in accordance with exemplary embodiments of the present disclosure.

FIG. 6B illustrates an example orientation of a single panel array of an imaging sensor system, in accordance with exemplary embodiments of the present disclosure.

FIG. 6C illustrates two staggered panel arrays of an imaging sensor system, in accordance with exemplary embodiments of the present disclosure.

FIG. 7A illustrates a RGB image of a scene captured with a RGB camera of an imaging sensor system, in accordance with exemplary embodiments of the present disclosure.

FIG. 7B illustrates a RGB-D image of a scene captured with a RGB-D camera of an imaging sensor system, in accordance with exemplary embodiments of the present disclosure.

FIG. 7C illustrates a RF image of a scene captured with a RF imaging sensor of an imaging sensor system, in accordance with exemplary embodiments of the present disclosure.

FIG. 8 illustrates a frame of a RGB video of a scene of an individual and a metal disc that the individual has tossed into the air, in accordance with exemplary embodiments of the present disclosure.

FIG. 9 illustrates a RGB image, a front view RF image and a profile view RF image corresponding to the RGB image captured by an imaging sensor system, in accordance with exemplary embodiments of the present disclosure.

FIG. 10 illustrates a RF image of an individual with a block of wax affixed to the torso of the individual captured by an imaging sensor system, in accordance with exemplary embodiments of the present disclosure.

FIG. 11 illustrates a RGB image and corresponding RF image captured by an imaging sensor system, in which an individual has their arms raised to their sides, with their legs spread shoulder width apart, in accordance with exemplary embodiments of the present disclosure.

FIG. 12 illustrates a number of offset points in a field of view of an RF imaging sensor of an imaging sensor system, over which the RF imaging sensor capture RF images of an individual as they move through the field of view of the RF imaging sensor and across one or more of the offset points at different ranges, in accordance with exemplary embodiments of the present disclosure.

FIG. 13 illustrates a ground truth labeling tool graphical user interface of an imaging sensor system, in accordance with exemplary embodiments of the present disclosure.

FIG. 14 illustrates a neural network based RF image object detection architecture of an imaging sensor system, in accordance with exemplary embodiments of the present disclosure.

FIG. 15A illustrates a RGB image of an individual carrying a backpack captured by an imaging sensor system, in accordance with exemplary embodiments of the present disclosure.

FIG. 15B illustrates a RF image of the individual carrying the backpack in FIG. 15A captured by an imaging sensor system, in accordance with exemplary embodiments of the present disclosure.

FIG. 16 illustrates different tasks that can be performed by a neural network based RF image object detection architecture of an imaging system, in response to processing a RF image, in accordance with exemplary embodiments of the present disclosure.

FIG. 17A illustrates a red, green, and blue depth (RGB-D) image of an individual from a side view captured by an imaging sensor system, in accordance with exemplary embodiments of the present disclosure.

FIG. 17B illustrates a red, green, and blue depth (RGB-D) image of an individual from a back view captured by an imaging sensor system, in accordance with exemplary embodiments of the present disclosure.

FIG. 18A illustrates keypoints added by an imaging sensor system to a RGB/RGB-D image corresponding to different joints of points of connection between different parts of the backside of an individual's body, in accordance with exemplary embodiments of the present disclosure.

FIG. 18B illustrates keypoints added by an imaging sensor system to a RGB/RGB-D image corresponding to different joints of points of connection between different parts of the front side of an individual's body, in accordance with exemplary embodiments of the present disclosure.

FIG. 19 illustrates an individual walking through a RF imaging sensor system with an array of panels situated on either side of the individual, in accordance with exemplary embodiments of the present disclosure.

FIG. 20A illustrates RF imaging sensors an imaging sensor system arranged at ninety degrees relative to each other, in accordance with exemplary embodiments of the present disclosure.

FIG. 20B illustrates opposingly spaced RF imaging sensors of an imaging sensor system, in accordance with exemplary embodiments of the present disclosure.

FIG. 20C illustrates RF imaging sensors of an imaging sensor system arranged at ninety degrees relative to each other, in accordance with exemplary embodiments of the present disclosure.

FIG. 20D illustrates RF imaging sensors disposed adjacent to each and at one hundred eighty degrees so that the fields of view of the RF imaging sensors extend in opposite directions of each other, in accordance with exemplary embodiments of the present disclosure.

FIG. 20E illustrates RF imaging sensors of an imaging sensor system illuminating various portions of an individual as they walk by the RF imaging sensors, in accordance with exemplary embodiments of the present disclosure.

FIG. 21 illustrates an embodiment of the multi-view imaging sensor system for processing aggregate detection information across multiple views, in accordance with exemplary embodiments of the present disclosure.

FIG. 22 illustrates a side profile fusion of a RF image of a scene including an individual and RGB image of the same scene, in accordance with exemplary embodiments of the present disclosure.

FIG. 23 illustrates a frontal view of a RF image of a scene including an individual and RGB image of the same scene, in accordance with exemplary embodiments of the present disclosure.

FIG. 24 illustrates different categories of output data products in the form of visual products or automated alert products, in accordance with exemplary embodiments of the present disclosure.

FIG. 25 illustrates task specific models of the imaging sensor system to determine when to issue an alert and/or alarm, in accordance with exemplary embodiments of the present disclosure.

### DETAILED DESCRIPTION

RF imaging in the microwave portion of the spectrum can be useful for detecting concealed threats because the illumination can pass through fabric materials while reflecting off of skin, metal, and other objects. However, the characteristics of active RF imaging are very different from optical (photographic) imaging, and therefore require unique methods of processing. Computer vision techniques that are used for object detection in photographic imaging might not always be directly applicable for object detection in RF images because the visual features (such as color, edges, texture, other patterns) are not statistically similar enough to apply computer vision techniques in RF imaging.

Instead of directly applying computer vision techniques to RF image, complex-values (i.e., real and imaginary, or magnitude and phase components) associated with a reflected RF signal corresponding to the RF image, are processed using one or more machine learning techniques in order to detect objects, classify a material from which the detected object is made, and detect anomalies in the RF image. The data associated with the RF image can be processed to determine features and classification rules that can be used to learn when an object of interest has been detected, a composition of the object, and to detect any anomalies that can be the in RF image.

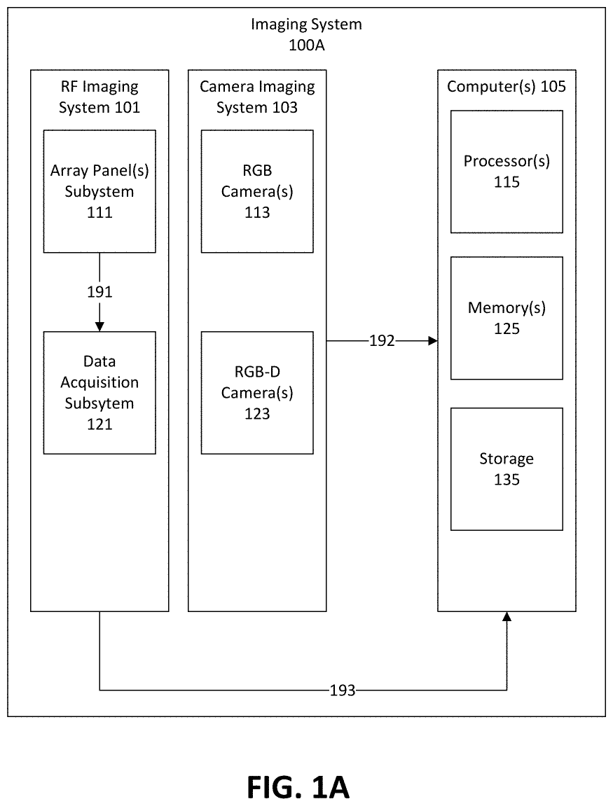

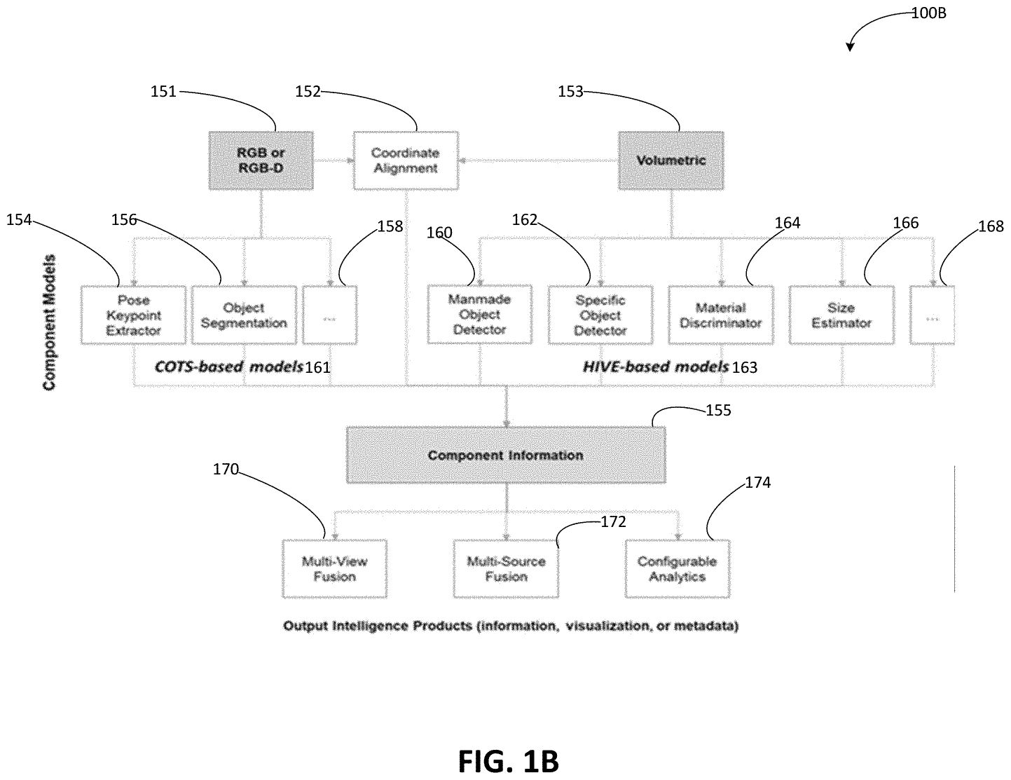

FIG. 1A illustrates a imaging sensor system 100A that images and detects concealed objects on the person of the individual based on one or more RF images, one or more red, green, blue (RGB) image data, and/or one or more red, green, blue depth (RGB-D) image data.

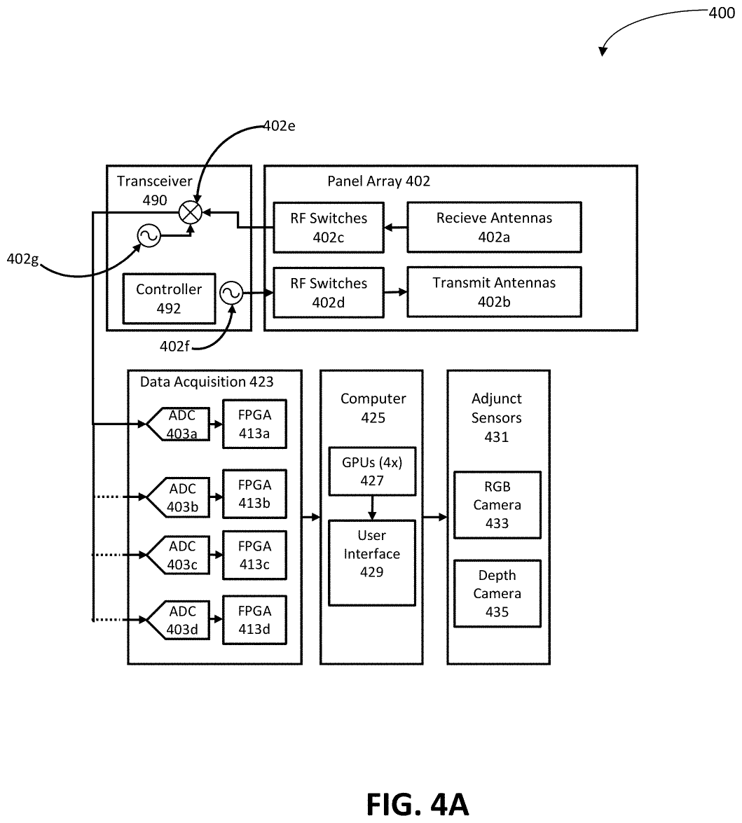

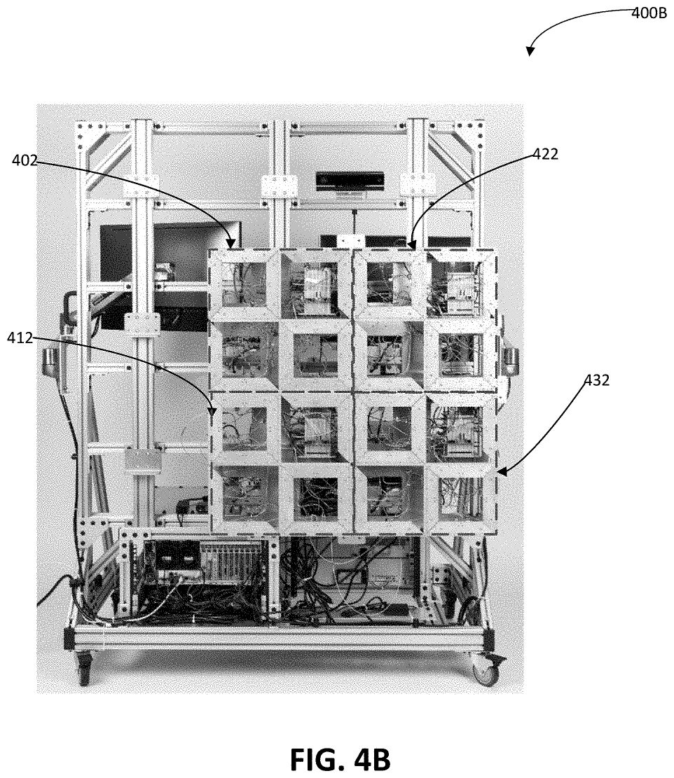

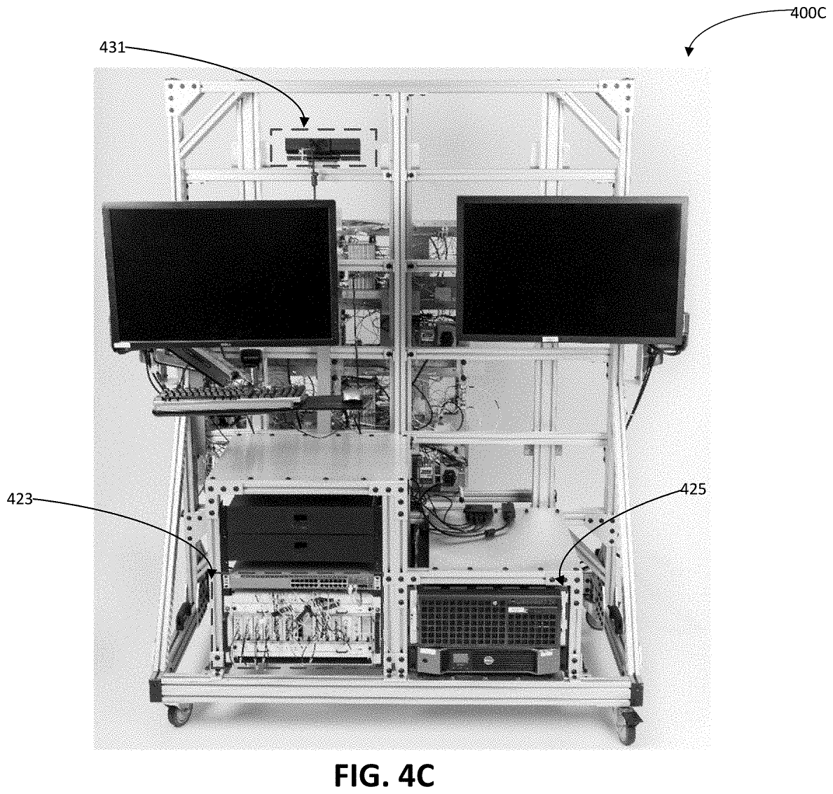

The imaging sensor system 100A includes a RF Imaging System 101, Camera Imaging System 103, and Computer(s) 105. RF Imaging System 101 comprises an array panel(s) subsystem 111 and a data acquisition subsystem 121. The array panel(s) Subsystem 111 can include a RF panel array that transmits and receives RF signals as described below in the descriptions of FIG. 1B and FIG. 4A. The RF signals are then processed by the data acquisition subsystem 121, to generate a RF image. The data acquisition subsystem 121 can include one or more analog to digital converters and one or more field programmable gate arrays (not illustrated) as discussed below in the description of FIG. 4A. Array panel(s) subsystem 111 send any return RF signals via connection 191 to data acquisition subsystem 121.

Camera imaging system 103 includes one or more RGB camera(s) 113 and/or one or more RGB-D camera(s) 123. The one or more RGB camera(s) 113 and one or more RGB-D camera(s) 123 generate RGB images and RGB-D images respectively.

Computer(s) 105 can ingest the RF image from RF imaging system 101, via connection 193, along with the one or more RGB images and the one or more RGB-D images from Camera Imaging System 103, via connection 192, and generate a composite image of the RF image and the one or more RGB images and the one or more RGB-D images. Connections 191 and connections 193 can be a bus, an Ethernet connection, a cable connection, an optics based connection, or a wireless connection. Connections 191 provides down-converted RF signals from the array panel(s) 111 to one or more analog-to-digital converters. The analog-to-digital converters can be included in the data acquisition system 121.

Computer(s) 105 can include one or more processor(s) 115, one or more memory(s) 125, and storage 135. The one or more processor(s) 115 can include one or more cores that are arranged to work in parallel or any other arrangement. The one or more memory(s) 125 can include random access memory, read only memory, solid state memory, etc. The storage 135 can include one or more hard disks that store the RF images and the one or more RGB and/or RGB-D images. In some embodiments, the storage 135 can be cloud storage. In this embodiment, the computer(s) 105 can transmit the composite image, RF image, and/or the one or more RGB/RGB-D images to one or more cloud storage devices.

FIG. 1B illustrates a process flow 100B illustrating fusing radio frequency (RF) signal, or volumetric data, with color or depth image data (e.g., red, green, and blue (RGB) data; or red, green, blue depth (RGB-D) data) by an embodiment of the imaging sensor system described herein to enable detection of concealed objects, classification of the concealed objects that are detected, visualization of the concealed objects, generation of configurable analytics, or a combination thereof.

FIG. 1B includes data blocks 151, 153, and 105. The remaining blocks in FIG. 1B represent processor modules. The data blocks 151, 153, and 155 generate data that is processed by one or more processor modules of the imaging sensor system. As an example, RGB/RGB-D data from data block 151 can represent data associated with a RGB or RGB-D images captured by one or more cameras of the imaging sensor system. For instance, the RGB/RGB-D data can include a number of pixels associated with the height and width of a scene, or a number of pixels associated with the depth of the scene. The RGB/RGB-D data associated with the depth of the scene can be based at least on time of flight data corresponding to the amount of time it takes light generated by a RGB/RGB-D camera to reflect from an object in the scene and return to the RGB/RGB-D camera. The RGB/RGB-D data can also include data associated with tracking one or more objects (e.g., a limb of an individual in a scene) as the object moves from one location, or position in the scene, to another position in the scene.

As another example, RF volumetric data from data block 153 can represent imaging data corresponding to RF signals generated by an RF imaging sensors. For instance, the imaging data can include one or more three-dimensional (3-D) (RF-based) images, and/or information about the one or more 3-D images. As another example, component information from data block 155 can represent a fusion of RGB or RGB-D data from data block 151 and RF volumetric data from data block 153 as combined by one or more computing devices of the imaging sensor system. RGB/RGB-D data 101, RF volumetric data 153, and component information data 155 can all be stored on a hard drive of a computer, or on one or more servers (e.g., cloud servers).

The processor modules process data corresponding to RGB/RGB-D data 151, RF volumetric data 153, component information data 155, or a combination thereof. For example, coordinate alignment module 152 can include one or more computer executable instructions that are executed by one or more processors to orient one or more first objects in an image generated by RGB/RGB-D data from RGB/RGB-D cameras with one or more second objects in an image generated by the RF volumetric data from RF imaging sensors. For example, the one or more processors can execute computer executable instructions included in the coordinate alignment module 152 to align legs, a torso, arms, and head of a person in the image generated by the one or more RGB/RGB-D cameras with the legs, torso, arms, and head of the person in the image generated by the RF imaging sensor.

Registration, between the RGB/RGB-D cameras and the RF imaging sensor is critical for aligning a detected object to its location on the person or in the scene. Alignment can be performed by applying an affine transformation matrix, T, to map 3-D coordinates in a RGB/RGB-D image domain (R), into 3-D (real world) coordinates in a RF image domain (R′). The coordinates in the RGB/RGB-D image domain correspond to coordinates in a RGB/RGB-D image, and the coordinates in the RF image domain correspond to coordinates in a RF image. The transformation matrix, T, contains coefficients that describe the translation, rotation, scaling, and shearing needed to align the coordinates. The coordinates in the RGB/RGB-D image R can be transformed into coordinates in the RF imaging sensor domain (R′) according to the following expression.

R′=TR

The coordinates in the RGB/RGB-D image domain (R) and the RF imaging sensor domain (R′) can be expressed

$$as R = [ \begin{matrix}x \\ y \\ z \\ 1\end{matrix} ] , \qquad {R}^{′} = [ \begin{matrix}{x}^{′} \\ {y}^{′} \\ {z}^{′} \\ 1\end{matrix} ] ,$$

and the transformation matrix can be expressed as

$$T = [ \begin{matrix}{a}_{1 , 1} & {a}_{1 , 2} & {a}_{1 , 3} & {a}_{1 , 4} \\ {a}_{2 , 1} & {a}_{2 , 2} & {a}_{2 , 3} & {a}_{2 , 4} \\ {a}_{3 , 1} & {a}_{3 , 2} & {a}_{3 , 3} & {a}_{3 , 4} \\ 0 & 0 & 0 & 1\end{matrix} ] .$$

The transformation matrix can be estimated in accordance with one of the two embodiments. In the first embodiment, the transformation matrix can be based at least in part on the physical geometry of the RGB/RGB-D sensor and the RF imaging sensor. More specifically, the position and field-of-view information associated with the RGB/RGB-D sensor and the RF imaging sensor, relative to one another, can be used to generate the coefficients in the transformation matrix. Using the physical location and geometry of the RGB/RGB-D sensor and RF imaging sensor, the coordinates in a RGB/RGB-D image domain (R), can be converted, or mapped into 3-D coordinates in a RF imaging sensor domain (R′).

An object detected in the RGB/RGB-D image can be aligned with an objected detected in the RF image, based at least in part on one or more of the following parameters. A size of a RGB image and a RGB-D image (expressed in units of pixels), a field of view of the RGB image and the RGB-D image (expressed in units of pixels), a center of the RGB image and the RGB-D image (i.e., a reference coordinate in a scene of the RGB/RGB-D image denoted by (0,0) is located) (expressed in units of pixels), a rotation matrix between the RGB image and the RGB-D image (relative to real world coordinates), and/or a translation vector between the RGB image and the RGB-D image (expressed in units of meters) can be used align a detected object in the RGB/RGB-D image with the detected objected in a RF image.

A processor can perform the alignment by converting information associated with the RGB-D image to a point cloud, converting the point cloud to real world coordinates using a transform derived from the one or more parameters mentioned above, and converting the real world coordinates to units of pixels in a target coordinate frame, which can be the RF image.

In another embodiment, if the physical relationship between the RGB/RGB-D camera and RF imaging sensors changes slightly, such as during transport, data associated with RGB/RGB-D images and RF images can be used to estimate the transformation matrix, T. A point cloud associated with the RGB/RGB-D camera can be transformed to a point cloud associated with the RF imaging sensor by performing a rigid transformation based at least in part on aligning, and then comparing points in the point cloud associated with the RGB/RGB-D camera, that are closest to points in the point cloud associated with the RF imaging sensor. The error or distance between the closest points is recorded. This process can be performed iteratively to improve the transformation until the error is reduced below a threshold.

The point clouds can be created by illuminating a subject or object that is located in different positions within a field of view of the RF imaging sensor (e.g., the subject or object is illuminated in a 3×3 grid (9 positions) that spans a volumetric area of the field of view of the RF imaging sensor). The point clouds, associated with the subject or object located in the different positions, are cropped to remove undesired aspects of in a corresponding RF image (e.g., background, floor, ceiling, etc.). The subject or object point clouds, associated with the subject or object located in the plurality of positions, is then overlaid and combined to form a single point cloud that looks like a grid of subjects or objects. Any noise in the points clouds associated with the subject or object, when the subject or object, is located in the plurality of positions can also be filtered, and then fused with the resulting single point cloud.

Data associated with the point cloud corresponding to the RGB/RGB-D camera and the RF imaging sensor are iteratively translated and rotated relative to another to achieve a rigid transformation matrix. More specifically, a processor of the imagining sensor system can attempt to match each point in the point cloud corresponding to the RGB/RGB-D camera to the closest point in the point cloud associated with the RF imaging sensor. The processor can estimate a transform that minimizes the root mean square error (RMSE) between all point pairs, and can apply the transformation to the point cloud associated with the RGB/RGB-D camera. The aforementioned process can be iterated until the error, or distance, between the closets points in the respective point clouds is less than a threshold.

An optimal transformation matrix can be found, after the error, or distance, between the closets points in the respective point clouds is less than the threshold. The processor can use the optimal transformation matrix to align points in a subsequently generated point cloud, associated with the RGB/RGB-D camera, with points subsequently generated in a point cloud, associated with the RF imagining senor. In some embodiments, the transformation matrix can be a 4×4 matrix, where the first three columns describe the rotation of points in a point cloud, associated with the RGB/RGB-D camera, to align with points in the point cloud, associated with a RF imaging sensor, and the last column can describe a translation of the points in the point cloud, associated with the RGB/RGB-D camera domain, to points in the point cloud, associated with the RF imaging sensor domain. In some embodiments, an accuracy metric can also be generated that describes the goodness of fit between the two point clouds.

Aligning the RGB/RGB-D image with the RF volumetric image ensures that when a concealed object of interest is detected in an image generated by the RF imaging sensors, a user viewing a fused RGB/RGB-D data and the RF imaging sensor data can accurately determine where the concealed object of interest is located on the body of the person in the RGB/RGB-D image. For instance, the RF volumetric data can reveal that an individual is carrying a metal canister, but because RGB/RGB-D images do not reveal concealed objects, the processor of the imaging sensor system executes the coordinate alignment module 102 to ensure that when a user views fused RGB/RGB-D data and RF volumetric data, it can be determined based on the fused RGB/RGB-D data and RF volumetric data that the metal canister is on the torso of the individual.

Pose keypoint extractor module 154 can include one or more computer executable instructions associated with a RGB/RGB-D convolutional neural network (CNN) that can be executed by the one or more processors of the imaging sensor system to determine certain keypoints on an individual associated with a pose of the individual. For example, the one or more processors can execute the pose keypoint extractor module 154 can receive the RGB/RGB-D image data from the one or more RGB/RGB-D cameras, and can execute instructions associated with the RGB/RGB-D CNN to determine points associated with an individual and/or an object the individual is carrying on their person in the scene of the image. Returning to the example above, the individual could be carrying a bag around their torso that includes the metal canister. The one or more processors can execute the pose keypoint extractor module 154 to identify locations in the RGB/RGB-D image data that correspond to the head, torso, arms, legs of the individual, as well as the bag of the individual. More specifically, the RGB/RGB-D CNN can cause the processor to place coordinates at key locations in the RGB/RGB-D image data corresponding to the individual's arms, legs, head, torso, and arms. These coordinates can be used to segment the body into smaller sections. As an example, the RGB/RGB-D CNN can be executed by the processor to identify a torso and the processor can indicate the location of the individual's torso by placing a coordinate in the RGB/RGB-D image data where the individual's left shoulder appears in the image, and placing a coordinate in the RGB/RGB-D image data where the individual's right shoulder appears in the image. The processor can also draw a first line connecting these two coordinates. The processor can also place a coordinate where the individual's right hip appears in the RGB/RGB-D image data and can also place a coordinate where the individual's left hip appears in the RGB/RGB-D image data. The processor can also draw a second line connecting these two coordinates. The processor can also draw a third line, e.g. perpendicular to the first and second lines, where the third line intersects the first and second lines.

The parts of an individual's body that are identified by the processor can be further segmented into smaller parts or sub-parts. As an example, the torso can be further segmented into smaller parts or sub-, such that, if the canister in the above example, is secured to the chest of the individual underneath a jacket, and the RF image reveals that it is secure to the individuals chest, the keypoints of the torso can be further segmented into a sub-part that includes a top half of the torso, where the top half of the torso can be defined by the processor as extending from the first line to a midpoint between the first and second lines along the third line. Similarly, the torso can be segmented into sub-part that includes a bottom half, where bottom half of the torso can be defined by the processor as extending from the second line to the midpoint between the first and second lines along the third line. Further still, the torso could be segmented in quadrants (e.g., upper right, upper left, lower right, lower left) as well, in similar way.

Object segmentation module 156 can include one or more computer executable instructions associated with the RGB/RGB-D CNN that can be executed by the one more processors to generate a segmentation mask in the RGB/RGB-D image data, where the segmentation mask can be associated with the individual and/or an object that the individual is carrying (e.g., a backpack, brief case, satchel, purse, or any other item that can conceal an object). For example, the processor can execute computer executable instructions associated with the RGB/RGB-D CNN to detect outermost regions of an individual captured in the RGB/RGB-D image data, and to generate a mask around the outermost region of the individual detected in the RGB/RGB-D image data. The one or more processing devices can execute the computer executable instructions associated with the RGB/RGB-D CNN to shade an area within a region defined by the mask to highlight and/or distinguish the individual from a remainder of the scene included in the RGB/RGB-D image data. If the individual is carrying an object such as a backpack, brief case, satchel, purse, etc. the processor can generate and apply a separate mask around the object and shade an area within a region defined by the mask around the object with a different color. In some embodiments, the keypoints can be overlaid on the mask.

COTS-based models 161 can also include additional modules 158 such as a line-of-sight estimation module or a body part segmentation module.

Manmade object detector module 160 can include one or more computer executable instructions associated with a RF imaging CNN that can be executed by one or more processors to detect concealed objects carried on an individual's person. Referring again to the above example using the canister, the RF imaging sensors can emit one or more RF signals toward the individual and detect a return signal in response to RF signals impinging upon the individual. As an example, at least some of the RF signals can be reflected upon impinging the individual to form the return signal. The return signal can be processed by one or more processors (e.g., graphical processing units (GPUs)) in order to generate one or more three dimensional (3-D) images. The one or more 3-D images can be processed by a RF imaging CNN to detect various objects within the one or more 3-D images corresponding to a field of view of the RF imaging sensors. Because the canister can be made out of metal, plastic, or porcelain, or another material, the returned signal from the canister can have a different set of signal propagation characteristics compared to the signal propagation characteristics of the return signal corresponding to the flesh of the individual.

The different signal propagation characteristics of the return signal can be visually distinguishable in the one or more 3-D images, and the processor executing computer executable instructions associated with the RF imaging CNN can discern the differences between the different materials or compositions (e.g., metal versus flesh) in the scene corresponding to the individual, as well as to other objects. As a result, the one or more processors can determine based on these differences that an object in the scene captured in the one or more 3-D images is a manmade object.

Specific object detector module 162 can include one or more computer executable instructions associated with the RF imaging CNN that can be executed by the one or more processors to detect a specific object carried on the individual's person. That is, the one or more processors can execute the specific object detector module 162 to determine that an object being carried on the individual is a canister, or other recognizable object.

Material discriminator module 164 can include one or more computer executable instructions associated with the RF imaging CNN that can be executed by the one or more processors to discern different materials from which an object being carried by an individual is made. For instance, returning to the metal canister example above, because the return signal characteristics are different than that of the flesh of the individual, and/or other objects that can be on the person of the individual, the one or more processors can compare the portion of the one or more 3-D images at which the metal canister is located to a plurality of known RF images that include objects that are also metal to determine that the object is indeed metal, and not made out of another material such as plastic or porcelain.

Size estimator module 166 can include one or more computer executable instructions associated with the RF imaging CNN that can be executed by the one or more processors to detect objects of a certain size. For example, if the metal canister is the size of thermos, the one or more processors can determine that the object is not a threat, and can be disregarded. However if the processor determines that the object is the size of a pressure cooker, the one or more processors can determine that the object is a threat and could be used, for example, as a bomb.

HIVE-based models 163 can also include additional modules 168 such as a body part segmentation module or a pose estimation module. The pose estimation module can a module that estimates the pose of a human being or animal.

Multi-source fusion module 170 can include one or more computer executable instructions that can be executed by one or more processors to fuse one or more outputs generated by one or more commercial off the shelf (COTS)-based modules 161 with one or more Hierarchical Interference for Volumetric Exploitation (HIVE)-based modules 613. More specifically, the one or more processors can execute instructions associated with the one or more of commercial of the shelf (COTS) based modules 161, and execute instructions associated with one or more Hierarchical Inference for Volumetric Exploitation (HIVE)-based modules 163, and fuse the output, by the one or more processors, of the one or more COTS-based modules 161 with the output, by the one or more processors, of the one or more HIVE based-modules 163.

For instance, the one or more processors of the imaging sensor system can execute one or more computer executable instructions associated with the multi-source fusion module 720 to overlay a rendering of an object detected in a RF image on top of a RGB/RGB-D image that includes a segmentation mask associated with the RF image of the individual, and/or one or more keypoints associated with the RGB/RGB-D image of the individual. Further still, the one or more processors can execute one or more computer executable instructions associated with the multi-source fusion module 170 to overlay a rendering of an object detected in the RF image on top of the RGB/RGB-D image that includes a segmentation mask associated with the RF image of the individual, along with a segmentation mask and the one or more keypoints associated with the RGB/RGB-D image of the individual.

For example, in some embodiments, the one or more processors can display the RGB/RGB-D image with an individual along with keypoints that determine a pose of the individual. The one or more processors can further display the RF image of an object, along with a segmentation mask around the object, that is on the person of the individual, or inside of a bag being carried by the individual overlaid on top of the RGB/RGB-D image.

Multi-view fusion module 172 can include one or more computer executable instructions that can be executed by the one or more processor to fuse RF images associated with the return signals from the RF imaging sensors, which can be positioned in different locations relative to the individual. More specifically, the computer executable instructions can be executed by the one or more processors to fuse or aggregate portions of the RF images corresponding to different segments of an individual's body that are associated with different point-of-views of the individual from the RF imaging sensors at the different locations. Each of the different points-of-views of the individual can be associated with a corresponding RF imaging sensors. For instance, if there is a first RF imaging sensor at a specific location of a right wall of a corridor, the RF images generated by the first RF imaging sensor can be associated with a first point-of-view of the individual. If there is a second RF imaging sensor on a specific location on a left wall of the corridor, the RF images generated by the second RF imaging sensor can be associated with a second point-of-view of the individual. If there is a RF imaging sensors on a portion of a floor and ceiling of the corridor, the RF images generated by the RF imaging sensor on the ceiling can be associated with a third point-of-view of the individual and the RF imaging sensor on the floor can be associated with a fourth point-of-view of the individual.

As an example, an individual can walk through a corridor. The walls, ceiling, and/or floor of the corridor can be equipped with one or more RF imaging sensors. The one or more RF imaging sensors can illuminate a portion of the area of the corridor through which the individual can walk through. The RF imaging sensors can detect one or more objects on the person of the individual from one or more of the first, second, third, and/or fourth point-of-views of the individual captured by the RF imaging sensors as the individual walks through the area illuminated by the RF imaging sensors.

The one or more processors can execute the multi-view fusion module 172 to fuse the RF images generated across the RF imaging sensors, and/or fuse a portion of the RF images that include an object detected on the person of the individual. Returning to the example of the individual carrying the canister, the processor can execute computer executable instructions corresponding to multi-view fusion module 172 to combine the portions of the RF images corresponding to the detected canister, where the combined portions of the RF images can combine the first, second, third, and fourth point-of-views.

Configurable analytics module 174 can include computer executable instructions associated with one or more configurable analytical models that can be executed by the one or more processors to generate configurable visual products or automated alerts associated with the detection of an object on an individual. The visual products, can include, but are not limited to a visual display of a segmented portion of a RGB/RGB-D image according to different portions of the body, and/or a visual display of a segmented portion of a detected object in a RF image, and/or the display of an anomaly detected in the RF image.

The automated alerts can include, but are not limited to, a visual or auditory alert associated with a characterization of a detected object in RF images. For instance, a processor can cause a visual alert to be displayed and/or an auditory alert to be sounded in response to determining that a detected object belongs to a class of a dangerous or potentially lethal objects based at least in part on the size, shape, and material of the object, and/or the contents of the object. A processor can also cause a visual alert to be displayed and/or an auditory alert to be sounded in response to a processor comparing the detected object to known dangerous or lethal objects, and determining that the object is a weapon that can be used in a dangerous or lethal manner.

The RF imaging sensors disclosed herein can include one or more microwave imaging sensing modalities that are well suited for detecting concealed threats on people or in carried items. The RF imaging sensors can use radio waves in the microwave portion of the electromagnetic spectrum to illuminate a scene and collect returned signals that can be reflected of people and/or objects in the scene. Energy in this portion of the electromagnetic spectrum is non-ionizing, and extremely low amounts of power are needed to generate an image. Additionally, while energy in this portion of the electromagnetic spectrum can pass through fabric materials, energy in this portion of the electromagnetic spectrum is reflected off of an underlying body or object, enabling detection of concealed threats. For these reasons, microwave imaging is a safe modality for the screening of people and items, and has been deployed in airports around the world. Radio frequencies typically used for these systems range from 6-40 GHz, but can include other bands. The RF imaging sensors discussed in this disclosure can be used in crowded places and facilities, such as mass transit systems, airports, stadiums, concert venues, museums, or other buildings.

The RF imagine sensors can capture RF images in real-time at a video rate (e.g., 10 frames per second), perform standoff imaging where individuals can be screened while they are in motion (e.g., walking down a corridor in a crowded space) without having to step into or through a designated location in order for the RF image to be captured. Because microwaves penetrate certain manmade materials, individuals do not have to remove bags to be imaged separately, as is the case with airport security checkpoint imaging systems. Further still, because the disclosed RF imaging sensors can be flat or planar they can be mounted to walls, ceilings, or housed in stand-alone panels.

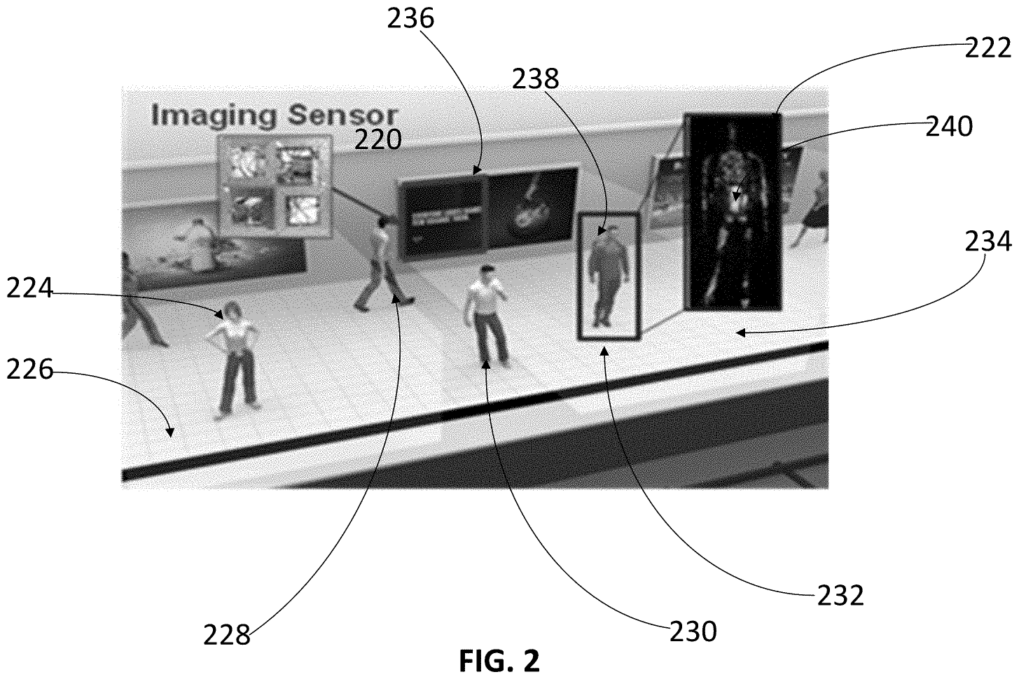

FIG. 2 illustrates an exemplary RF imaging sensor (e.g., RF imaging sensor 220) embedded in an advertisement display 236 on a wall of a subway platform. Individual 232 is in field of view 234. RF imaging sensor 220 can illuminate a field of view 232 with microwave signals that are reflected off of individuals (e.g., individual 232), and measure corresponding return microwave signals. After the imaging sensor 220 detects a return signal reflected from individual 232, a processor can generate a RF image (e.g., RF image 222) of individual 232. In this scene individual 232 is carrying a bag (e.g., bag 238) on the individual's back, which is depicted in RF image 222 as object 240 in yellow.

Individual 230 is not within the field of view of the RF imaging sensors, and an as result, a RF image of individual 230 cannot be generated. Individual 228 is partially in field of view 226 and partially outside of field of view 226. More specifically, the arms, torso, and head of individual 228 is not in field of view 226 and the legs of individual 228 are in field of view 226. As result, a RF image of the arms, torso, and head of individual 228 is not generated, but a RF image of the legs of individual 228 is generated. Individual 224 is in field of view 226, generated by another RF imaging sensor (not illustrated) and therefore a corresponding RF image of individual 224 similar to RF image 240 can be generated, by the processor. Individual 224 is not carrying an external object, so the RF image generated by the processor of individual 224 cannot include an indication that individual 224 is carrying an object. However, it is possible that individual 224 is carrying an object concealed under their clothing, in which case the processor can detect the object and generate a RF image indicating the presence of that object.

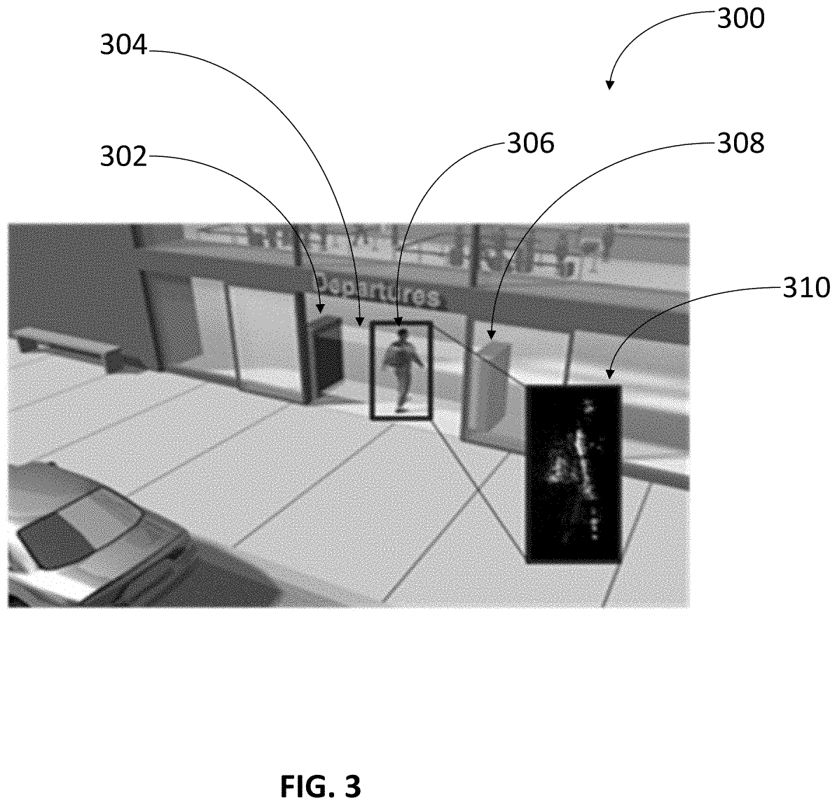

FIG. 3 illustrates an exemplary multi-view RF imaging sensor system 300 comprising a first RF imaging sensor (e.g., RF imaging sensor 302) and a second RF imaging sensor (e.g., RF imaging sensor 308), and a field of view 304 corresponding to the intersection of a first field of view of the first RF imaging sensor and a second field of view of the second RF imaging sensor. The RF imaging sensor system illustrated in FIG. 3 can be referred to as a multi-view RF imaging sensor system, because it includes more than one RF imaging sensor and therefore more than one corresponding field of view associated with the RF imaging sensors. Individual 306 is carrying a bag, and RF image 310 indicates that the location of the bag on the person of individual 306.

FIG. 4A illustrates a logical relationship between one or more hardware and software modules for transmitting, receiving, and processing one or more RF signals in the imaging sensor system.

The RF panel arrays are also referred to as RF imaging sensors. Imaging sensor system 400 is a self-contained mobile RF imaging sensor system of the imaging sensor system that can easily be moved from one location to another because it is supported on wheels. Although in other embodiments, the RF imaging sensors, data acquisition and processing system 423 includes analog digital converters (ADCs) 403a-403d and field programmable gate arrays (FPGAs) 413a-413d, and adjunct sensors 431 might not be collocated with the computer 425. In some embodiments the computer 425, can be located in a back office location or network closet that is in the same building as the RF imaging sensors, adjunct sensors 431, and the data acquisition and processing system 423. In other embodiments, the computer 425 can be separated from the RF imaging sensors, adjunct sensors 431, and the data acquisition and processing system 423, by a large geographic distance, and therefore can be connected to the RF imaging sensors, adjunct sensors 431, and the data acquisition and processing system 423 via the Internet using any of a wireless network connection (IEEE 802.11-Wireless Fidelity (Wi-Fi) Standards, IEEE 820.16-Worldwide Interoperability for Microwave Access (WiMAX)), a cellular connection (e.g., UMTS, GSM, CDMA, 2G, 3G, 4G, 5G etc.), or a hardwired connection (IEEE 802.3-Ethernet). In this scenario, the data acquisition and processing system 423 can be communicatively coupled to a processor (not shown) which is further connected to a transceiver that transmits one or more packets or frames including a compressed version of RF return signals, that have been processed by the data acquisition and processing system 423, and correspond to RF signals reflected from objects and/or individuals in the field of view of the RF imaging sensors, to the computer 425 using a wireless or wired connection.

The panel array 402 can comprise a plurality of transmit antennas 402b, a corresponding set of transmitter RF switches (e.g., RF switches 402d), and a corresponding transmitter local oscillator (e.g., transmitter local oscillator 402f) that changes the frequency of a signal that is transmitted by transmit antennas 402b. The panel array 402 can comprise a plurality of receive antennas 402a, a corresponding set of receiver RF switches (e.g., RF switches 402c). The panel array 402 also includes a transceiver (e.g., transceiver 490) including a mixer (e.g., mixer 402e) and a receiver local oscillator (e.g., receiver local oscillator 402g), a transmitter local oscillator (e.g., transmitter local oscillator 402f), and a controller (e.g., controller 492). Controller 492 can control, or regulate, the switching of the array panel and frequency tuning of transmitted RF signals. Controller 492 can regulate the timing of the frequency sweep for each of the plurality of transmit antennas 402b. Controller 492 can be a Complex Programmable Logic Device (CPLD), that stores switch biases for a plurality of switch states for RF switches 402d. The CPLD can send a pulse to the RF switches 402d thereby toggling the RF switches 402d sequentially. The CPLD can store a state list in a local memory that can be used to reset the switch states of the RF switches 402d by pulsing a Reset input to the RF switches 402d.

In some embodiments, the plurality of transmit antennas 402b can include a set of 144 transmit antennas and the plurality of receive antennas 402a can include a set of 144 receive antennas.

The imaging sensor system 400 can illuminate a field of view of the imaging sensor system 400, by energizing the RF switches 402d to rapidly switch between transmitting on different antennas of the transmit antennas 402b, and energizing RF switches 402c to switch between the different antennas of the receive antennas 402a. As the imaging sensor system 400 transmits signals across the different transmit antennas 402b, via the RF switches 402d, and receives the reflected transmitted signals across receive antennas 402a via the RF switches 402c, the imaging sensor system 400 can collect spatially-diverse reflection measurements of a scene. The transmitted RF signals can be a continuous wave (CW) waveform that can be tuned from 24-29 GHz. That is, the transmitter local oscillator 402f can be tuned to apply a frequency within the range of 24-49 GHz to an analog signal that is transmitted from the RF panel array. Similarly the receiver local oscillator 402g can be tuned to receive a reflected RF signal, with a frequency between 24-49 GHz, corresponding to a reflected version of the transmitted RF signals.

FIG. 4B illustrates an imaging sensor system 400B comprising four RF panel arrays (e.g., panel arrays 402, 412, 422, and 432). Panel arrays 402, 412, 422, and 432, each comprise the following RF front end components, including, but not limited to a set of transmitter RF switches, a set of receiver RF switches, a plurality of receive antennas, and a plurality of transmit antennas. These RF front end components are the same as the RF front components in panel array 402. For example, panel array 402 can include a plurality of transmit antennas that are analogous to the plurality of transmit antennas 402b, and a set of transmitter RF switches that are analogous to the RF switches 402d. Panel array 402 can also include a plurality of receive antennas that are analogous to the plurality of receive antennas 402a, and a set of receiver RF switches that are analogous to RF switches 402c. As illustrated in FIG. 4, panel arrays 412, 422, and 432 can be identical to panel array 402. In some embodiments, the dimensions, and therefore the number of transmit antennas, transmitter RF switches, receive antennas, and receiver RF switches, can be different between the panel arrays 402-432.

FIG. 4C illustrates a RF signal processing system 400C comprising a data acquisition and processing system 423, a computer 425, and adjunct sensors 431. Data acquisition and processing system 423 can include a plurality of analog-to-digital converters (not depicted), a computer 425, and adjunct sensors 431.

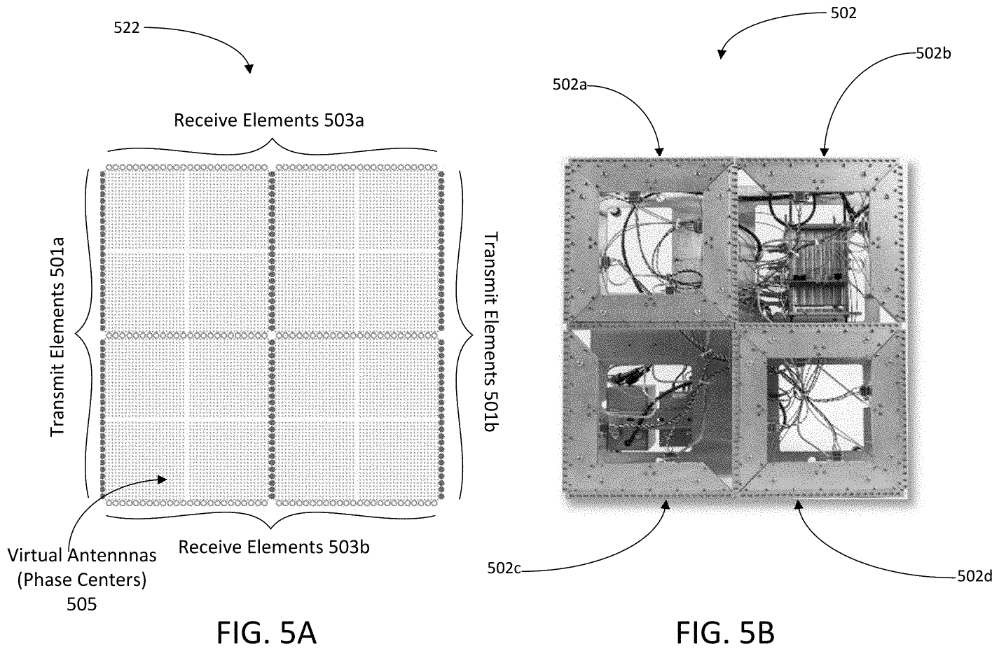

FIG. 5B illustrates an exemplary panel array 502 and FIG. 5A illustrates a panel array tile 522 corresponding to a single tile of the four panel array tiles in panel array 502. Panel array 502 can comprise the four panel array tiles including tile 502a, tile 502b, tile 502c, and tile 502d. Panel array tile 522 is a diagrammatic representation of the different components of panel array tile 502a. Panel array tile 522 can comprise transmit elements 501a, transmit elements 501b, receive elements 503a, receive elements 503b, and virtual antenna locations 505 (which can also be referred to as phase centers) that corresponds to a given transmit element, of the transmit elements 501a or 501b, and a given receive element, of the receive elements 503a or 503b. In some embodiments, there can be a total of 144 transmit elements and a total of 144 receive elements. That is transmit elements 501a can comprise a first number of transmit antennas, and transmit elements 501 can comprise a second number of transmit antennas, where the sum of the first number and the second number equals 144 transmit elements. receive elements 503a can comprise 144 receive antennas. In some embodiments, there can be an equal number of transmit elements in transmit elements 501a and transmit elements 501b, resulting in 72 transmit elements for 501a and 72 transmit elements for 501b. Similarly there can be an equal number of receive elements in receive elements 503a and receive elements 503b, resulting in 72 receive elements for 503a and 72 receive elements for 503b.

A phase center can correspond to a pair including a transmit element and a receive element. For example, a phase center can correspond to a 31^{st} transmit element and a 91^{st} receive element. By transmitting the RF signal using the 31^{st} element and measuring, or monitoring, a return signal on the 91^{st} element, a processor can determine the location and depth of an individual and/or object relative to these elements. In general, when a transmit element transmits a signal on one element and measures the reflections of that signal off of an individual or object, on one or more (usually several) receive elements, the system, and more specifically the processor, can generate a three-dimensional image of the environment (field of view).

In some embodiments, panel array tiles 502b, 502c, and/or 502d can be identical to panel array tile 502a. In other embodiments, panel array tiles 502b, 502c, and/or 502d can include different numbers of transmit elements and/or receive elements.

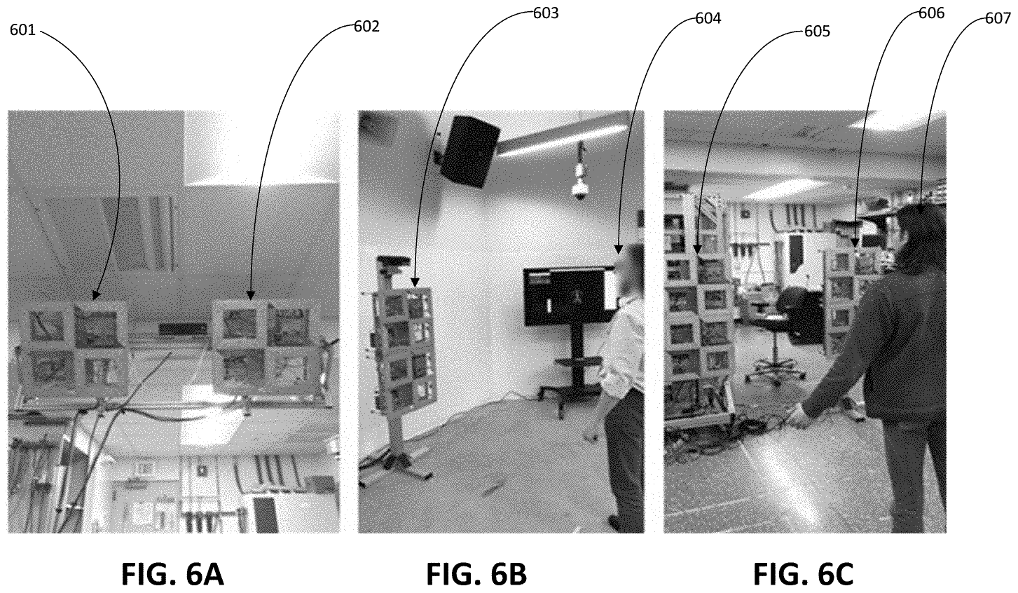

FIG. 6A illustrates an orientation of two panel arrays (panel array 601 and panel array 602) suspended from a ceiling. This orientation can enable a RF imaging system to illuminate a scene from above, thereby providing a cross sectional RF image of an individual from above. Accordingly, if the individual is carrying a bag on their person, the RF imaging system can generate a RF image of the bag and contents of the bag from above.

FIG. 6B illustrates an orientation a single panel array 603 that is directly in front of individual 604. In this orientation the single panel array 603 can illuminate a scene covering the height and width of the ventral side of individual 604. This orientation could be used to determine if individual 604 has an item concealed under his/her clothes on the ventral side of their body.

FIG. 6C illustrates two staggered panel arrays 605 and 606 in front of individual 607. This orientation can be referred to as a multi-view RF imaging sensor, where panel array 605 is used to illuminate the left ventral side of individual 607 and panel array 606 is used to illuminate the right ventral side of individual 607. The RF image generated in response to return signal from the RF signal emitted by panel array 605 can be processed separately and in parallel with the RF image generated in response to response signal from the RF signal emitted by panel array 607, and the two RF images can be fused to generate a multi-view RF image of individual 607, or any items carried in a bag by individual 607 or concealed by individual 607.

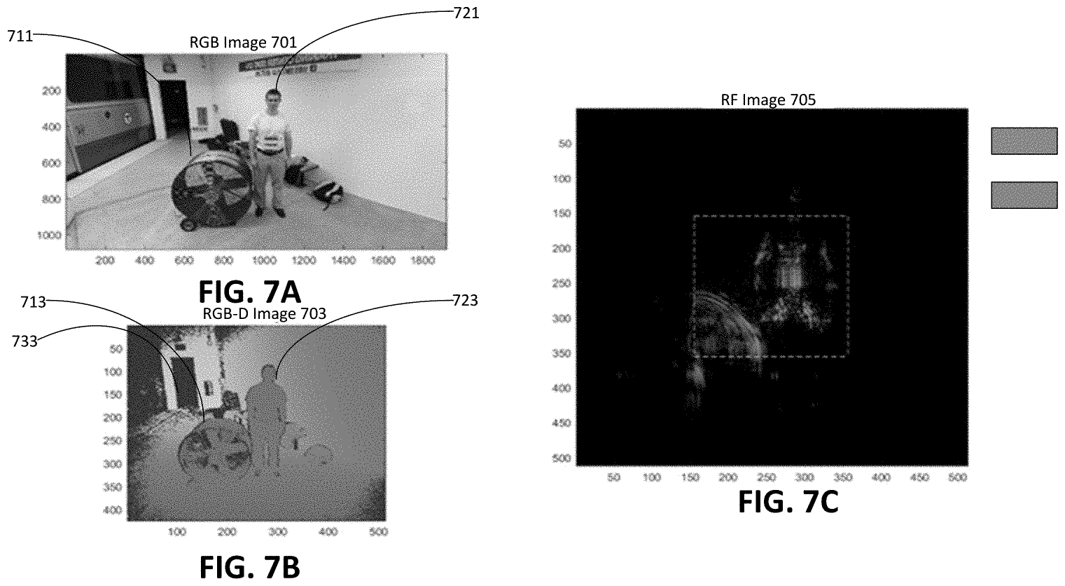

FIG. 7A illustrates a RGB image 701 of a scene captured with a RGB camera of an adjunct sensor. For example, RGB camera 433 of adjunct sensors 431, can capture a field of view that includes an individual 721 who is standing to the right of fan 711, both of which are approximately the same distance away from an aperture of the RGB camera. The vertical axis corresponds to the number of pixels in each column, and the horizontal axis corresponds to the number of pixels in each row of the RGB image 701. The number of pixels in each column in RGB image 701 is 1920, and the number of pixels in each row in RGB image 701 is 1080. As a result the size of RGB image 701 can be 1080×1920.

FIG. 7B illustrates a RGB-D image 703 of a scene captured with a RGB-D camera of an adjunct sensor. For example, depth camera 435 of adjunct sensors 431, can capture a field of view that includes the individual 721 who is standing to the right of the fan 711, both of which are approximately the same distance away from an aperture of the RGB-D camera. The different colors in the RGB-D image 703 indicate the distance away from the aperture of the RGB depth camera. Portions of the scene that are closer to the aperture of RGB-D camera can be a shade of blue, portions of the scene that are further away from the RGB-D camera can be a shade of yellow, and portions of the scene that are in between these portions of the scene can be a shade of green. For instance, an orange-yellow shaded portion of RGB-D image 703 can correspond to a wall including a door 733 indicating that the wall and door 733 is further away from the aperture of the RGB-D camera, than the individual 721 and fan 711 which are depicted in a shade of blue. The portions of RGB-D image 703 that are in between the door 733 and the individual 723 and fan 713 is depicted in a shade of green, which indicates that the area of the scene depicted in green is further away from the aperture of RGB-D camera than the individual 723 and fan 713, but closer to the aperture of RGB-D camera than the door 733. The vertical axis corresponds to the number of pixels in each column, and the horizontal axis corresponds to the number of pixels in each row of the RGB image 701. The number of pixels in each column in RGB image 701 is 512, and the number of pixels in each row in RGB image 701 is 424. As a result the size of RGB image 701 can be 1080×1920.

FIG. 7C illustrates a RF image 705 of a scene captured with a RF imaging sensor. For example, RF image 705 can be a RF image captured by RF imaging sensor corresponding to panel array 402, data acquisition 423, and computer 425. FIG. 7C illustrates a RF image of the scene illustrated in FIG. 7A. The individual 721 is assigned a shade of green, and fan 711 is assigned a shade of orange in FIG. 7C. The different colors in FIG. 7C indicate the depth, or distance, of an object away from the RF imaging sensor, as well the effect of the material on a RF signal. The shade of green in FIG. 7C can indicate that individual 721 is further away from the aperture of the RF imaging sensor and the shade of orange-red in FIG. 7C can indicate that the fan 711 is closer to the aperture of the RF imaging sensor. The torso, arms, and legs of individual 721 are shown in FIG. 7C because the RF signals generated by the RF imaging sensor are reflected off of the flesh of individual 721, and returned to the RF imaging sensor. Because the torso, arms, and legs contain a significant amount of muscle, the RF signals will return a strong RF signal that can be measured by the RF imagining sensor.

When the RGB camera, RGB depth camera, and RF imaging sensor capture images of a scene, the imaging sensor system can be operating in a snapshot operational mode. The raw RF return signal reflected from objects in a scene, can be used to construct RF images at arbitrary range. These RF images can be used to construct 3D RF image volumes where each 3D RF image constructed using a 512 point Fast Fourier Transform (FFT) corresponding to a vertical direction of the scene and 512 point FFT corresponding to the horizontal direction of the scene, along with and a variable number of depth slices. The depth slices can be different depths of a physical space corresponding to the scene in which a RF signal is sent. For instance, the RF imaging sensor can transmit a series of RF signals to different distances in the physical area to create a 3D volumetric RF image. As an example, the RF imaging sensor can be configured to transmit RF signals to 21 or 32 different depths of a physical space corresponding to a scene, each of the 21 or 32 depths can be separated by a certain distance. For instance, the depths can be separated by 0.015 meters. The RGB images can be 1920 pixels by 1080 pixels, and the RGB depth images can be based on a time of a time-of-flight camera image of the scene, and the RGB depth images can be 512 pixels by 424 pixels. An individual in the scene can be tracked based on positions of the individual's joints using keypoints as mentioned above.

The imaging sensor system can also operate in a video operational mode. In the video operational mode, the RGB camera can record RGB video footage of a scene, and a GPU can be generate RF video footage at a rate of 10 Hz based on RF signal reflected from subjects and/or objects in the scene.

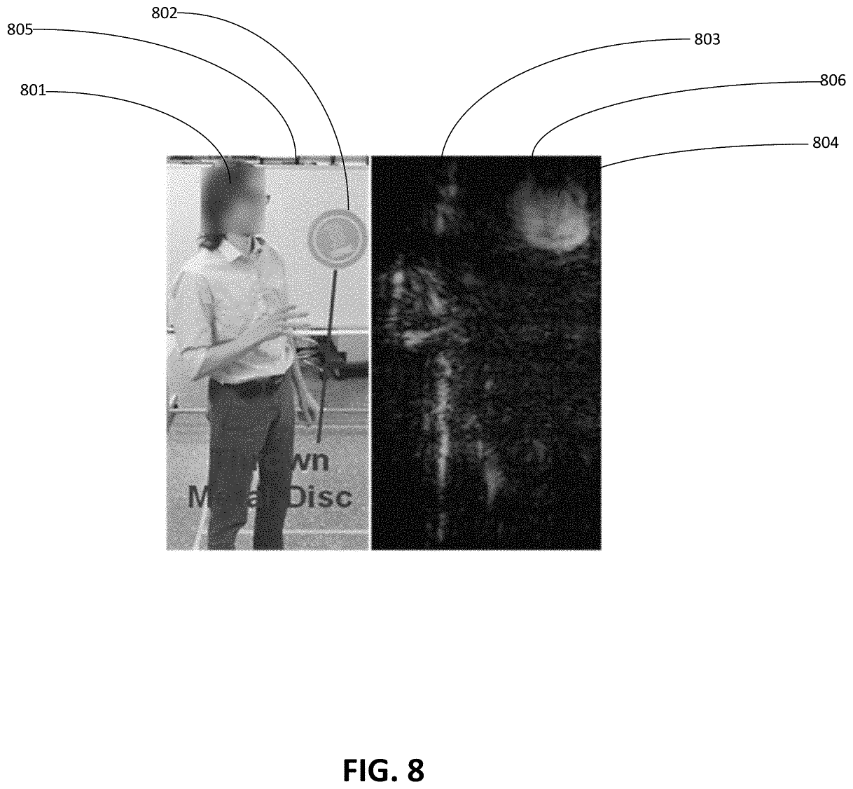

FIG. 8 illustrates a RGB image 805 of RGB video footage of a scene of an individual 801 and a metal disc 802 that the individual 801 tossed into the air. RF image 806 is a screenshot of RF video footage of the same scene of the individual 801 and disc 802. RF subject 803 corresponds to a RF image of individual 801, and RF object 804 corresponds to a RF image of disc 802. The yellow-orange shade of RF subject 803 indicates that the right arm and right leg of individual 801 is closer to the aperture of RF imaging sensor than the head, chest, left leg, left shoulder, and left arm, which have a fuchsia shade to indicate that these parts of individual 801 are further away from the aperture of RF imaging sensor that the right arm and right leg of the individual 801. The yellow-orange shade of the RF object 804 indicates that disc 802 was closer to the aperture of the RF imaging sensor and the fuchsia shade of the RF object 804 indicates that the disc 802 was further away from the aperture of the RF imaging sensor, in midflight. This means that the disc 802 was tossed into the air at an angle.

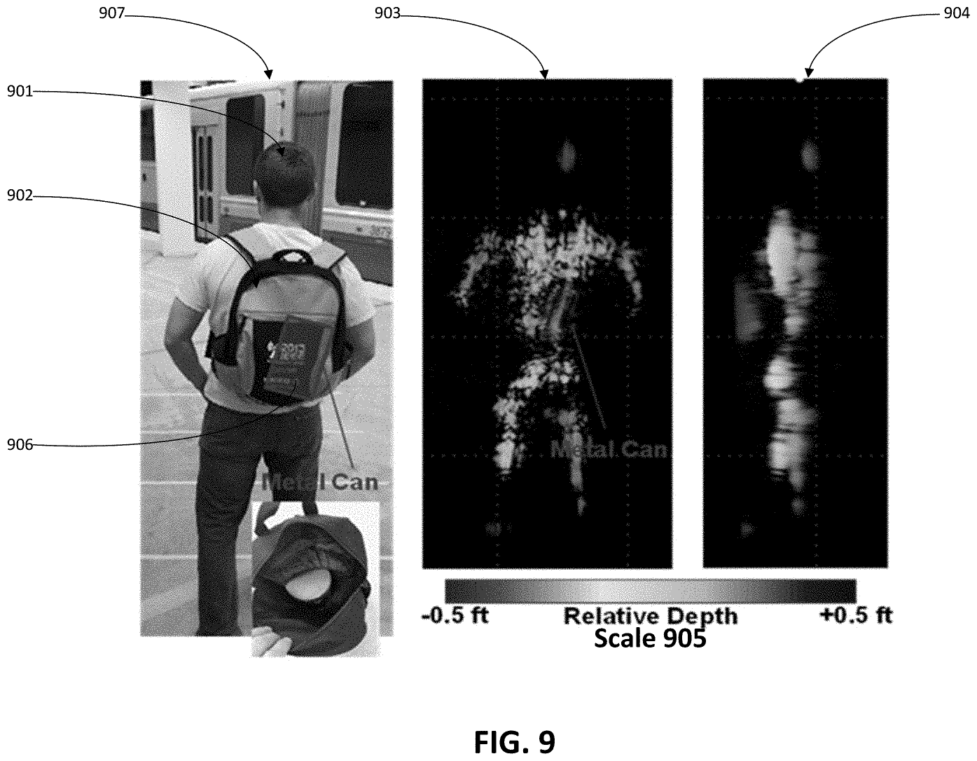

FIG. 9 illustrates a RGB image 907, and a front view RF image 903 and a profile view RF image 904 corresponding to the RGB image 907. The RGB image 907 includes individual 901, who is carrying backpack 902, with a RGB segmentation mask 906 corresponding to the location where a metal can is concealed in the backpack 902. The front view RF image 903 is a front view of individual 901 in the RF image domain, and the profile view RF view 904 is a profile view of individual 901 in the RF image domain Front view RF image 903 includes a relative depth scale 905 which indicates the distance of different parts of the scene away from the aperture of the RF imaging sensor. The reference point for the relative depth scale 905 in FIG. 9, can be a cross-sectional reference plane through the torso from the top downward through individual 901. That is, the reference point is a widthwise cross-sectional reference plane that extends the length of individual 901 from the top of individual's 901 torso through and to the bottom of individual's 901 torso.

RF image 903 is a RF image of individual 901, where blue shaded portions in RF image 903 correspond to body parts, or portions, of individual 901 that are in front of the reference plane. In FIG. 9, individual 901 is facing away from an aperture of the aperture of an RF imaging sensor. That is the RF imagining sensor is behind individual 901, and the field of view of the RF imaging sensor is the backside of individual 901. Because the reference plane corresponds to a cross-sectional reference plane through the torso from the top downward along the length of individual 901, the torso and hips (which are just beneath the torso), of individual 901, can correspond to a greenish yellow color in the RF image. As indicated by scale 905, a greenish yellow color corresponds to a distance of 0 feet which corresponds to the reference point. As a result, portions of the RF image colored with a bluish tint, correspond to parts of individual 901, or objects, that are further away from the RF imaging sensor. For example, as shown in RF image 903, the head, left arm, right leg, and left lower abdominal portion of individual 901 correspond to the bluish tinted shaded portions, which are in front of this reference plane, and therefore are facing away from the aperture of the RF imaging sensor. The green-yellow portions of RF image 903 indicate that the corresponding body parts of the torso, hips, and left leg are in line with the reference plane, and therefore closer to the aperture of the RF imaging sensor than the head, left arm, right leg, and left lower abdominal portion of individual 901. The teal shaded portion of RF image 903 indicates that the corresponding body part, or portion, of individual 901 is slightly in front of the reference plane, and therefore further away from the aperture than the head, left arm, right leg, and left lower abdominal portion of individual 901. The teal shaded portion of RF image 903 corresponds to the right arm of individual 901. In RGB image 907, the right arm of individual 901 is slightly in front of the torso of individual 901, thereby causing the right arm of individual 901 to appear teal in RF image 903. Because the metal canister is located in the backpack 902, and the backpack 902 is on the back of individual 901, the red portion of RF image 903 can indicate that the metal canister is behind the reference plane, and therefore being carried on the back of individual 901.

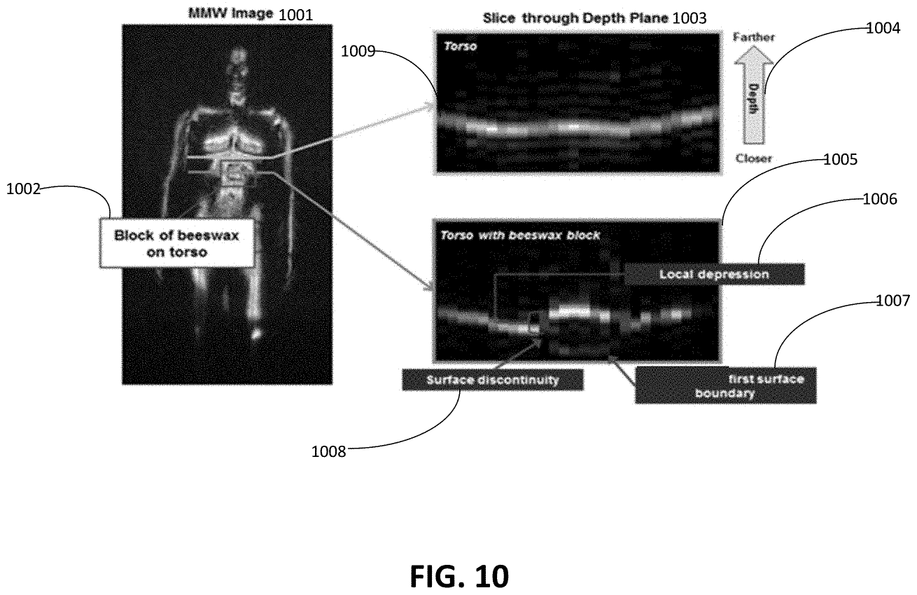

Energy in the microwave spectrum (e.g., 6-40 GHz) interacts with different materials in different ways. The energy does not pass through the human body, but reflects off of skin. Metal materials are very highly reflective. Fabrics are generally transparent. Other non-conductive (dielectric) materials such as plastics can slow or distort the waveform, creating artifacts that could be automatically detected by algorithms. FIG. 10 provides an example of how a block of wax (dielectric material), such as a block of beeswax 1002, appears in an image, a millimeter wave (MMW) image 1001, collected over 18-26 GHz. The transmitted RF signal is slowed by the wax material, which makes the wax block appear to be farther away than the surface of the individual's torso, thereby creating the appearance of an indentation.

A slice through depth plane 1003 corresponds to a RF image depth slice of a torso of an individual from the ventral side of the individual to the dorsal side of the individual. As mentioned above, RF images are 3D volumetric images, where the depth of the RF images correspond to a plurality of slices. The slice through depth plane 1003 corresponds to a concatenation of slices, where a front surface 1009 of the torso corresponds to a RF image representation of the ventral side of the individual. The depth 400 of the torso in the slice through depth plane 1003 increases away from torso front surface 1009. The front surface 1009 of the torso is closest to the RF imaging sensor, and corresponds to the ventral side of the individual because the RF imaging sensor is facing the ventral side of the individual. The depth 1004 increases away from the torso front surface 1009 toward the dorsal side of the individual.

A slice through depth plane 1005 corresponds to a RF image depth slice of the torso of the individual form the ventral side of the individual to the dorsal side of the individual. Because the individual has a container with a substance included in it, in this case beeswax, secured to their torso, a processed return RF signal reflected from the container and the beeswax inside of the container, can cause a torso front surface discontinuity 1008. The surface discontinuity 1008 occurs because the RF signal transmitted by the RF imaging sensor that reflects off of the container of beeswax is less dense than the flesh of the individual, the time it takes for the reflected RF signal to return to the RF imaging sensor from the container will take a longer period of time than the reflected RF signal to return to the RF imaging sensor from the individual's torso. As result, the processed reflected RF signals from the container and the individual's torso, will make it appear as though there is a local depression 1006 in the torso of the individual where the container of beeswax is secured to the individual. The first surface boundary 1007 corresponds to the outside of the container containing the beeswax.

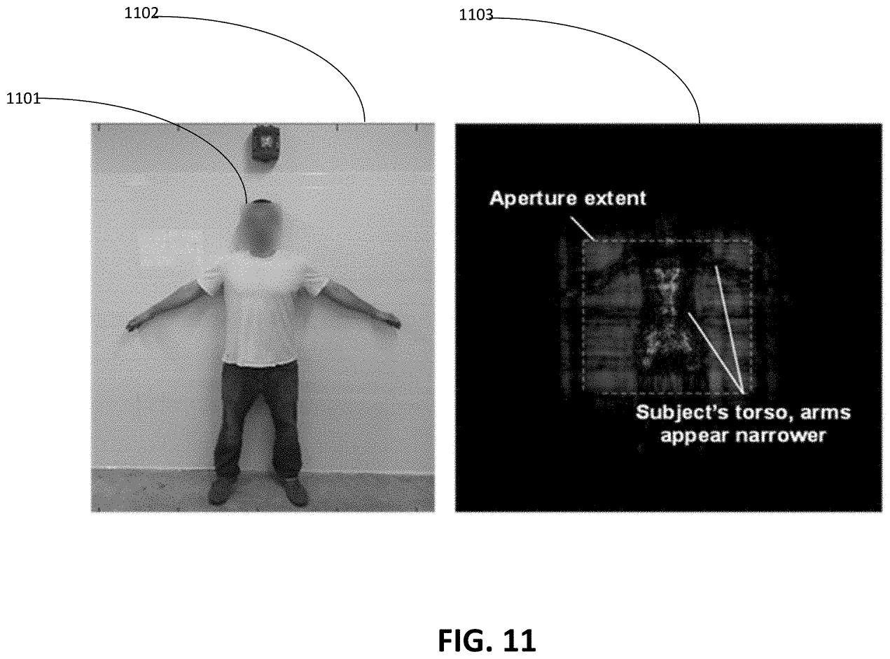

The RF signals used to illuminate a scene, can reflect from a surface at a similar angle to the incident angle (this can be referred to as specular reflection), or reflect at an angle that is equal to the incident angle (this can be referred to as diffuse scattering), such that the reflected RF signals scatter in different directions at different angles. In the microwave regime, specular reflection arises when an electrically large (i.e., much greater than the signal wavelength) flat target is observed. Because of this, when a RF imaging sensor receives specular reflected RF signals large, flat targets can appear as though they are not present in a RF image when they are tilted away from the aperture of the RF imaging sensor. Furthermore, cylindrical or curved objects can appear as though they are narrower than they actually are. This can be observed in FIG. 11.

FIG. 11 illustrates a RGB image 1102 and corresponding RF image 1103, in which an individual 1101 has his arms raised to his sides, with his legs spread shoulder width apart. RF image 1103 depicts the aperture extent, which corresponds to the field of view of the RF imaging sensor illuminated by a panel array. The subject's torso and arms appear artificially narrower, than they do in the corresponding RGB image, due to the specula reflection effect.

Parts of the scene outside of the footprint of the aperture of the RF imaging sensor, have limited visibility due to the specular reflection effects. A larger aperture also provides a more detailed image. This is due, in part, to increased resolution, but also increased illumination diversity. The imaging sensor systems disclosed herein can have, for example, a nominal size of 1 meter×1 meter, which is sufficient to form RF images of a human subject.

The imaging sensor systems can generate RF images of subjects within, for example, approximately a 3 foot and 15 foot range. The image clarity varies with range, as the resolution degrades linearly when a subject moves away from the aperture of the RF imaging sensor.

Because RF imaging in the microwave portion of the spectrum is useful for illuminating concealed threats due to the fact that RF signals can pass through fabric materials while reflecting off of skin, metal, and other objects, the complex valued data associated with the RF images, can be processed using one or more of the neural network techniques described herein to detect certain concealed threats, subjects, and/or other objects in a scene of the imaging sensor system.

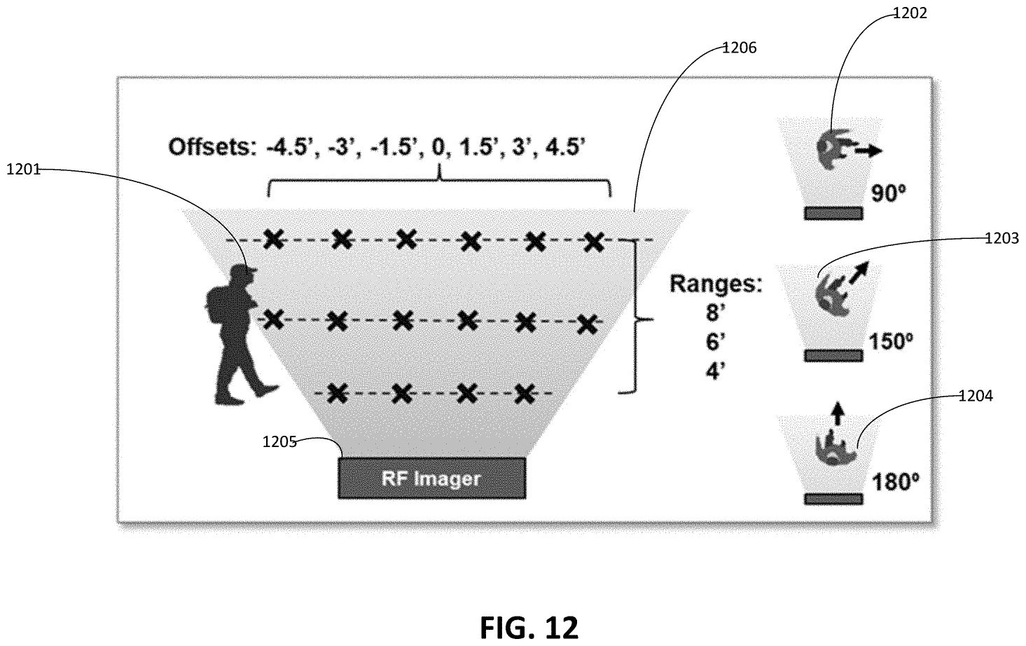

To facilitate training of the neural network techniques disclosed herein, RF imagery data can be systematically collected in a controlled setting. In some embodiments, RF imagery data can be collected by one or more operators of the imaging sensor system, and the one or more operators can identify one or more target items, of interest, in a scene of the RF imagery data and input instructions to the imaging sensor system to detect the one or more target items using the neural network techniques. In one or more control settings, a test subject, with or without an object on their person, moves throughout the field of view of the RF imaging sensor, and can stop at various positions within the field of view, and the RF imaging sensor can collect RF images in the snapshot mode of operation. Positions can be defined as a lateral offset from the center of the field of view (e.g., +1 foot, +2 feet), and range, or distance between the subject and/or object in the scene, to the RF imaging sensor (e.g., 4 feet, 6, feet, 8 feet). The angle of the individual with respect to the RF imaging sensor can also be varied (e.g., the dorsal side of the individual is facing the RF imaging sensor, the ventral side of the individual is facing the RF imaging sensor, or the individual is at an angle between facing the RF imaging sensor or facing away from the RF imaging sensor). For example, FIG. 12 illustrates a number of offset points over which the RF imager 1205 (this can also be referred to as a RF imaging sensor) can take snapshots of the individual 1201 as they move through the field of view 1206 and traverse one or more of the offsets at different ranges. As the individual 1201 traverses the field of view 1206, the individual 1201 might not follow a non-linear path resulting in the individual 1201 turning their body as they traverse the field of view 1206. For example, if the individual 1201 were facing the same direction in which the RF imager is illuminating field of view 1206, the individual would have a zero degree angle offset, because they are facing the same direction of illumination of the field of view 1206 (i.e., the back of individual 1201 is facing RF imager 1205). It should be noted that the individual 1201 could have a zero degree angle offset even if the individual 1201 were not directly in front of the RF imager 1205. That is the individual 1201 could be standing at an offset point between of −3′ and −4.5′ and between a range 4′ and 6′ and have a zero degree angle offset so long as the individual 1201 is facing the same direction of illumination of field of view 1206. A zero degree angle offset corresponds to the exact opposite of a 180 degree offset of the individual 1204. The body of the individual 1201 could also have a 90 degree angle offset similar to the individual 1202 or 150 degree angle offset similar to the individual 1203 as they walk through the field of view 1206.

The one or more operators can review one or more RF images as the individual 1201 traverses the field of view 1206, and determine when one or more items of interest, whether it be the individual 1201 and/or an objects of interest, is being carried on the person of individual 1201. The one or more operators can log the one or more items of interest, via a user interface (e.g., user interface 429), into a memory. A GPU (e.g., GPU 427), can execute computer executable instructions, also stored in the memory, to train the neural network based on the one or more items of interest that were identified by the one or more operators. The GPU can execute the computer executable instructions, to train the neural network to detect the one or more items of interest without the intervention of the one or more operators.

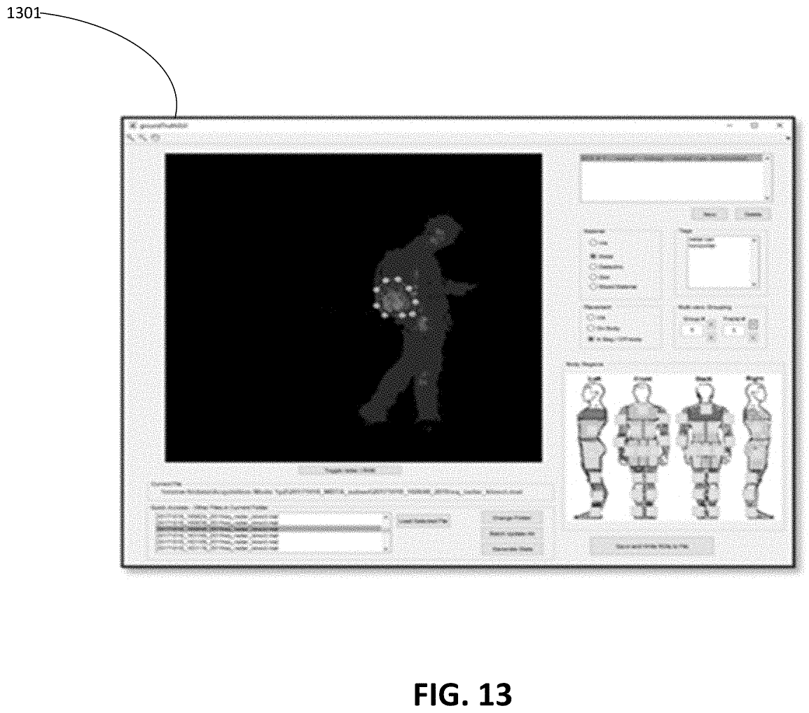

The one or more operators can log the information using a ground truth labeling tool graphical user interface 1301 as illustrated in FIG. 13. The ground truth labeling tool graphical user interface 1301 can receive inputs from the one or more operators to mark an object of interest. The ground truth labeling tool graphical user interface 1301 includes a markup tool, that allows the one or more operators to draw shapes around the object of interest in a RF image. For example, the ground truth labeling tool graphical user interface 1301 can render the shape of a polygon encompassing the object of interest on a display device. The ground truth labeling tool graphical user interface 1301 can also receive as an input, a name associated with the object of interest, the type of material the object of interest is made out of, and/or the placement of the object of interest on the person of the individual, or separate from the individual and at some location in the scene by itself. The ground truth labels are captured in a two dimensional space (x,y).

The inputs to the ground truth tool graphical user interface 1301 can be recorded on one or more computer storage devices (e.g., hard drives), and used as inputs into the neural network to train the neural network to identify the object of interest. The one or more operators can log locations in the field of view of the RF imaging sensor, over which the object of interest moves in order to train the neural network to detect the object of interest regardless of the location and angle at which the object of interest is relative to the RF imaging sensor.

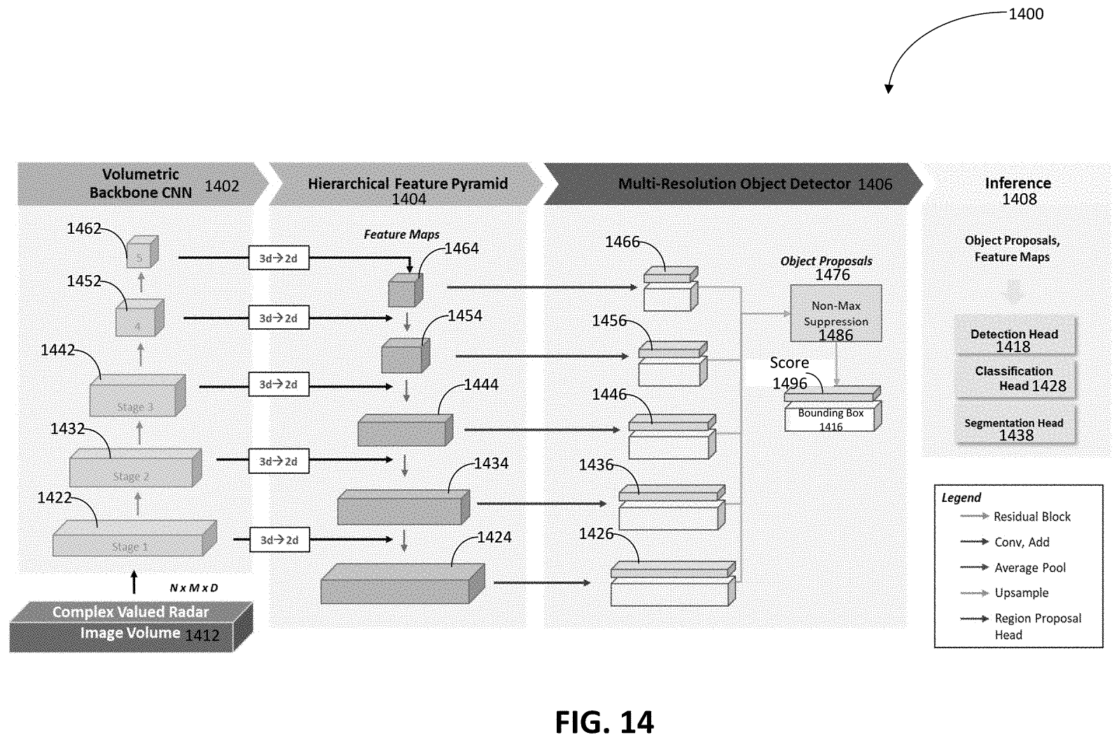

FIG. 14 illustrates a neural network based RF image object detection architecture, in accordance with exemplary embodiments of the present disclosure. RF object detection architecture 1400 includes a volumetric backbone convolutional neural network (CNN) module 1402 that processes an RF image, which can also be referred to as an image volume, to determine features about the RF image that can be used by an object detector module to detect objects in the RF image. Each of the determined features can correspond to a stage of processing by the volumetric backbone CNN 1402. RF object detection architecture 1400 includes a hierarchical feature pyramid 1404 that combines each feature generated by the volumetric backbone CNN 1402 at each stage with another feature generated by the volumetric backbone CNN 1402 from another stage. RF object detection architecture 1400 includes a multi-resolution object detector 1406 that inputs the combined features from different stages in order to select portions of the RF image that can contain an object or region-of-interest. The multi-resolution object detector 1406 can include an object proposal 1476 module that includes a non-max suppression 1486 module, a score 1496 module, and a bounding box 1416 module. The RF object detection architecture 1400 also includes an inference 1408 module, that a processor can execute to detect the object, classify the object, and segment the object from other objects or individuals in the RF image. The processor can execute instructions associated with a detection head 1418 module, to detect the object in the RF image. The processor can execute instructions associated with a classification head 1428, to classify the object in the RF image, and can execute instructions associated with a segmentation head 1438 to segment the object in the RF image.

The volumetric backbone CNN 1402 can input a complex valued radar image volume 1412 which is a RF image that can be expressed as a complex valued three-dimensional matrix with N rows, M columns, and D depth slices. For instance, there can be D=5 depth slices and for each depth slice there can be N=10 rows of data and M=10 columns of data in the matrix for each depth slice. Because the RF image includes real and imaginary components, or a magnitude and phase components, the data associated with the RF image can have two channels associated with it.

The processor executes one or more instructions associated with the volumetric backbone CNN 1402 resulting in the processor inputting each of the real and imaginary components of the complex valued RF image, and applying the process below to the real and imaginary components in parallel to generate feature maps, for the RF image, at each stage 1 1422, stage 2 1432, stage 3 1442, stage 4 1452, and stage 5 1462. The processor will identify one or more features in the feature map as a result of executing instruction associated with each of stage 1 1422, stage 2 1432, stage 3 1442, stage 4 1452, and stage 5 1462. These one or more features can be used by the processor to detect an object in the image a varying degrees of resolution associated with each of the stages.

The volumetric backbone CNN 1402 can be a 50-layer deep CNN in which the 50 layers of the deep CNN are associated with one of the stages. For instance, the first stage 9 (stage 1 1422) can include a single layer comprising a 7×7 filter with 64 different feature maps that the processor will generate in response to applying the 7×7 filter to the real and imaginary components of the complex valued RF image and outputting a smaller RF image with a resolution that is smaller than the RF image input to the volumetric backbone CNN 1402 at stage 1 1422. For instance, in some embodiments the resolution of the RF image after the 7×7 filter has been applied by the processor can be 80 units in height by 80 units in width.

The second stage (stage 2 1432) can include three sets of three layers. Each set can include three layers, where the first layer in the set comprises a 1×1 filter with 64 feature maps that the processor will generate in response to applying the 1×1 filter to the real and imaginary components of the complex valued RFimage that is output in the first stage, and input to the second stage. The second layer in each set comprises a 3×3 filter with 64 feature maps that the processor will generate in response to applying the 1×1 filter to the real and imaginary components of the complex valued RFimage that is output by the first layer in the second stage. The third layer in each set comprises a 1×1 filter with 64 feature maps that the processor will generate in response to applying the 3×3 filter to the real and imaginary components of the complex valued RFimage that is output by the second layer in the second stage. The output of the first set will be input to the second set, the output of the second set will be input to the third set. The output of the third set will be input to the first layer in the first set in the third stage. The resolution of the RF image output in the second stage can be 80 units in height by 80 in width.

The third stage (stage 3 1442) can include four sets of three layers. Each set can include three layers, where the first layer in the set comprises a 1×1 filter with 128 feature maps that the processor will generate in response to applying the 1×1 filter to the real and imaginary components of the complex valued RFimage that is output by the third layer in the second stage, and input to first layer in the third stage. The second layer in each set comprises a 3×3 filter with 128 feature maps that the processor will generate in response to applying the 1×1 filter to the real and imaginary components of the complex valued RFimage that is output by the first layer in the third stage. The third layer in each set comprises a 1×1 filter with 512 feature maps that the processor will generate in response to applying the 3×3 filter to the real and imaginary components of the complex valued RFimage that is output by the second layer in the third stage. The output of the first set will be input to the second set, the output of the second set will be input to the third set. The output of the third set will be input to the fourth layer in the second. The output of the fourth set will be input to the first layer in the first set in the fourth stage. The resolution of the RF image output in the third stage can be 40 units in height by 40 units in width.

The fourth stage (stage 4 1452) can include six sets of three layers. Each set can include three layers, where the first layer in the set comprises a 1×1 filter with 256 feature maps that the processor will generate in response to applying the 1×1 filter to the real and imaginary components of the complex valued RFimage that is output by the third layer in the third stage, and input to the fourth stage. The second layer in each set comprises a 3×3 filter with 256 feature maps that the processor will generate in response to applying the 1×1 filter to the real and imaginary components of the complex valued RFimage that is output by the first layer in the fourth stage. The third layer in each set comprises a 1×1 filter with 1024 feature maps that the processor will generate in response to applying the 3×3 filter to the real and imaginary components of the complex valued RFimage that is output by the second layer in the fourth stage. The output of the first set will be input to the second set, the output of the second set will be input to the third set. The output of the third set will be input to the fourth layer in the second. The output of the fourth set will be input to the fifth layer, and the output of the fifth layer will be input to the sixth layer. The sixth layer in the fourth set will be input to the first layer in the fifth stage. The resolution of the RF image output in the fourth stage can be 20 units in height by 20 units in width.

The fifth stage (stage 5 1462) can include three sets of three layers. Each set can include three layers, where the first layer in the set comprises a 1×1 filter with 512 feature maps that the processor will generate in response to applying the 1×1 filter to the real and imaginary components of the complex valued RFimage that is output by the third layer in the fourth stage, and input to the fifth stage. The second layer in each set comprises a 3×3 filter with 512 feature maps that the processor will generate in response to applying the 1×1 filter to the real and imaginary components of the complex valued RFimage that is output by the first layer in the fifth stage. The third layer in each set comprises a 1×1 filter with 2048 feature maps that the processor will generate in response to applying the 3×3 filter to the real and imaginary components of the complex valued RFimage that is output by the second layer in the fifth stage. The output of the first set will be input to the second set, the output of the second set will be input to the third set. The output of the third set will be input to the first layer in the first set in the third stage. The resolution of the RF image that is output in the fifth stage can be 20 units in height by 20 units in width.

Below is a brief description about how the processor applies the filters and generates the corresponding feature maps at each of the stages mentioned above.

The processor can execute one or more instructions associated with volumetric backbone CNN 1402 causing the processor to input the complex valued radar image volume 1412 and applying one or more feature maps at stage 1 1422 to the complex valued three-dimensional matrix. The one or more feature maps can correspond to weights associated with a feature in the RF image, and stage 1 1422 can have one or more layers corresponding to a CNN. That is, each of the one or more feature maps can have corresponding weights associated with it, and the processor can apply each of the weights to the complex valued radar image volume 1412, in the one or more layers in stage 1 1422. In some embodiments, the one or more layers, can include a filter that corresponds to a matrix with I rows and J columns, where I is less than N and J is less than M. The processor applies the weights to the complex valued radar image volume 1412 by parametrizing the filter with the weights. That is, the entries in the matrix corresponding to the filter are values associated with the weights of a feature map. Thus at stage 1 1422, the processor can input the complex valued radar image 1412, and apply the filter to the complex valued radar image 1412, and output a filtered version of the complex valued radar image 1412 to stage 2 1432. The processor can convolve the filtered version of the complex valued radar image 1412 with a 1×1 filter, and output the filtered version of the complex valued radar image 1412 to module 1424. The filtered version of the complex valued radar image 1412 can be defined by the number of depth, height, and width pixels. In some embodiments, the filtered version of the complex valued radar image 1412 can be defined by 9 depth pixels, 80 height pixels, and 80 width pixels. The filtered version of the complex valued radar image 1412 can be further defined by the number of feature maps associated with the filtered version of the complex valued radar image 1412. In some embodiments, there can be a total of 64 feature maps associated with the filtered version of the complex valued radar image 1412.

At stage 2 1432, the processor executes one or more instructions associated with volumetric backbone CNN 1402 causing the processor to input the filtered version of the complex valued radar image volume 1412 and applying one or more feature maps at stage 2 1432 to a complex valued three-dimensional matrix associated with the filtered version of the complex valued radar image volume 1412. The one or more feature maps at stage 2 1432, can correspond to weights associated with a feature in the RF image, and stage 2 1422 can have one or more sets of layers corresponding to a CNN.

For instance, stage 2 1432 can include m sets of layers. As an example, m can be said to be equal to 3. A first set, of the m sets of layers, can include n layers. As an example, n can be said to be equal to 3 as well. A first layer, of the 3 layers, from the first set of the 3 sets of layers, can be associated with one or more first feature maps, and each of the one or more first feature maps can have corresponding first weights associated with them. A second layer, of the 3 layers, from the first set of the 3 sets of layers, can be associated with one or more second feature maps, and each of the one or more second feature maps can have corresponding second weights associated with them. A third layer, of the 3 layers, from the first set of the 3 sets of layers, can be associated with one or more third feature maps, and each of the one or more third feature maps can have corresponding third weights associated with them.

The input to the first set of layers, of the 3 sets of layers, is the filtered version of the complex valued radar image volume 1412. The output of the first set of layers, of the 3 sets of layers, is input to the second set of layers, of the 3 sets of layers, and the output of the second set of layers, of the 3 sets of layers, is input to the third set of layers, of the 3 sets of layers.

The processor can apply the first weights to the filtered version of the complex valued radar image volume 1412, in the first layer of the first set of layers, of the 3 sets of layers, in stage 2 1432. The first layer of the first set of layers, can include a first filter that corresponds to a first matrix A₁₁ with B₁₁ rows and C₁₁ columns, where B₁₁ can be less than or equal to I and C₁₁ can be less than or equal to J. The processor applies the first weights to the filtered version of the complex valued radar image volume 1412 by parametrizing the first filter with the first weights. That is, the entries in the first matrix corresponding to the first filter are values associated with the first weights of a first feature map, of the one or more first feature maps, for the first layer of the first set of layers. After the processor applies the first weights to the filtered version of the complex valued radar image volume 1412, the processor outputs a first layer output associated with the first set of layers, of the 3 sets of layers, to the second layer in the first set of layers, of the 3 sets of layers.

The processor can then apply the second weights to the first layer output, in the second layer of the first set of layers in stage 2 1432. The second layer of the first set of layers, of the 3 sets of layers, can include a second filter that corresponds to a second matrix A₁₂ with B₁₂ rows and C₁₂ columns, where B₁₂ can be greater than or equal to B₁₁ and C₁₂ can be greater than or equal to C₁₁. The processor applies the second weights to the first layer output by parametrizing the second filter with the second weights. That is, the entries in the second matrix corresponding to the second filter are values associated with the second weights of a second feature map, of the one or more second feature maps, for the second layer of the first set of layers, of the 3 sets of layers. After the processor applies the second weights to the first layer output, the processor outputs a second layer output associated with the first set of layers, of the 3 sets of layers, to the third layer of the first set of layers, of the 3 sets of layers.

The processor can then apply the third weights to the second layer output, in the third layer of the first set of layers, of the 3 sets of layers, in stage 2 1432. The third layer of the first set of layers, can include a third filter that corresponds to a third matrix A₁₃ with B₁₃ rows and C₁₃ columns, where B₁₃ can be less than or equal to B₁₂ and C₁₃ can be less than or equal C₁₂. The processor applies the third weights to the second layer output by parametrizing the third filter with the third weights. That is, the entries in the third matrix corresponding to the third filter are values associated with the third weights of a third feature map, of the one or more third feature maps, for the third layer of the first set of layers. After the processor applies the third weights to the second layer output, the processor outputs a third layer output associated with the first set of layers, of the 3 sets of layers, to a first layer of the second set of layers, of the 3 sets of layers.

The second set, of the 3 sets of layers, can also include 3 layers. A first layer, of the 3 layers, from the second set of the 3 sets of layers, can be associated with one or more first feature maps, and each of the one or more first feature maps can have corresponding first weights associated with them. A second layer, of the 3 layers, from the second set of the 3 sets of layers, can be associated with one or more second feature maps, and each of the one or more second feature maps can have corresponding second weights associated with them. A third layer, of the 3 layers, from the second set of the 3 sets of layers, can be associated with one or more third feature maps, and each of the one or more third feature maps can have corresponding third weights associated with them.

In some embodiments, first weights associated with the first layer, of the second set of the 3 sets of layers, can be equal to the first weights associated with the first layer, of the first set of the 3 sets of layers. In some embodiments, second weights associated with the second layer, of the second set of the 3 sets of layers, can be equal to the second weights associated with the second layer, of the first set of the 3 sets of layers. In some embodiments, third weights associated with the third layer, of the second set of the 3 sets of layers, can be equal to the third weights associated with the third layer, of the first set of the 3 sets of layers.

The processor can apply the first weights, associated with the first layer, of the second set of the 3 sets of layers, to the third layer output from the first set of the 3 sets of layers. The first layer of the second set of layers, of the 3 sets of layers, can include a first filter that corresponds to a first matrix A₂₁, where A₂₁ can be equal to A₁₁. The processor applies the first weights to the third layer output by parametrizing the first filter with the first weights. That is, the entries in the first matrix A₂₁ corresponding to the first filter are values associated with the first weights of a first feature map, of the one or more first feature maps, for the first layer of the second set of layers. After the processor applies the first weights to the third layer output, the processor outputs a first layer output associated with the second set of layers, of the 3 sets of layers, to the second layer in the second set of layers, of with the 3 sets of layers.

The processor can then apply the second weights to the first layer output associated with the second set of layers, of the 3 sets of layers. The second layer of the second set of layers, of the 3 sets of layers, can include a second filter that corresponds to a second matrix A₂₂, where A₂₂ can be equal to A₁₂. The processor applies the second weights to the first layer output by parametrizing the second filter with the second weights. That is, the entries in the second matrix A₂₂ corresponding to the second filter are values associated with the seconds weights of a second feature map, of the one or more second feature maps, for the second layer of the second set of layers. After the processor applies the second weights to the first layer output, the processor outputs a second layer output associated with the second set of layers, of the 3 sets of layers, to the third layer of the second set of layers, of the 3 sets of layers.

The processor can then apply the third weights to the second layer output associated with the second set of layers, of the 3 sets of layers. The third layer of the second set of layers, of the 3 sets of layers, can include a third filter that corresponds to a third matrix A₂₃, where A₂₃ can be equal A₁₃. The processor applies the third weights to the second layer output by parametrizing the third filter with the third weights. That is, the entries in the third matrix corresponding to the third filter are values associated with the third weights of a third feature map, of the one or more third feature maps, for the third layer of the second set of layers. After the processor applies the third weights to the second layer output, the processor outputs a third layer output associated with the second set of layers, of the 3 sets of layers, to a first layer of the third set of layers, of the 3 sets of layers.

The third set, of the 3 sets of layers, can also include 3 layers. A first layer, of the 3 layers, from the third set of the 3 sets of layers, can be associated with one or more first feature maps, and each of the one or more first feature maps can have corresponding first weights associated with them. A second layer, of the 3 layers, from the third set of the 3 sets of layers, can be associated with one or more second feature maps, and each of the one or more second feature maps can have corresponding second weights associated with them. A third layer, of the 3 layers, from the third set of the 3 sets of layers, can be associated with one or more third feature maps, and each of the one or more third feature maps can have corresponding third weights associated with them.

The processor can apply the first weights, associated with the first layer, of the third set of the 3 sets of layers, to the third layer output from the second set of the 3 sets of layers. The first layer of the third set of layers, of the 3 sets of layers, can include a first filter that corresponds to a first matrix A₃₁, where A₃₁ can be equal to A₁₁. The processor applies the first weights to the third layer output by parametrizing the first filter with the first weights. That is, the entries in the first matrix A₃₁ corresponding to the first filter are values associated with the first weights of a first feature map, of the one or more first feature maps, for the first layer of the third set of layers. After the processor applies the first weights to the third layer output, the processor outputs a first layer output associated with the third set of layers, of the 3 sets of layers, to the second layer in the third set of layers, of the 3 sets of layers.

The processor can then apply the second weights to the first layer output associated with the third set of layers, of the 3 sets of layers. The second layer of the third set of layers, of the 3 sets of layers, can include a second filter that corresponds to a second matrix A₃₂, where A₃₂ can be equal to A₁₂. The processor applies the second weights to the first layer output by parametrizing the second filter with the second weights. That is, the entries in the second matrix A₃₂ corresponding to the second filter are values associated with the seconds weights of a second feature map, of the one or more second feature maps, for the second layer of the third set of layers. After the processor applies the second weights to the first layer output, the processor outputs a second layer output associated with the third set of layers, of the 3 sets of layers, to the third layer of the third set of layers, of the 3 sets of layers.

The processor can then apply the third weights to the second layer output associated with the third set of layers, of the 3 sets of layers. The third layer of the third set of layers, of the 3 sets of layers, can include a third filter that corresponds to a third matrix A₃₃, where A₃₃ can be equal A₁₃. The processor applies the third weights to the second layer output by parametrizing the third filter with the third weights. That is, the entries in the third matrix corresponding to the third filter are values associated with the third weights of a third feature map, of the one or more third feature maps, for the third layer of the third set of layers, of the 3 sets of layers. After the processor applies the third weights to the second layer output, the processor outputs a third layer output associated with the third set of layers, of the 3 sets of layers, to a first layer of a first set of layers, of l sets of layers, in stage 3 1442. In some embodiments, l can be equal to 4.

The processor can convolve the third layer output associated with the third set of layers, of the 3 sets of layers in stage 2 1432, with a 1×1 filter, and output the filtered version of the third layer output associated with the third set of layers, of the 3 sets of layers in stage 2 1432, to module 1424. The third layer output associated with the third set of layers, of the 3 sets of layers in stage 2 1432 can be defined by the number of depth, height, and width pixels. In some embodiments, the third layer output associated with the third set of layers, of the 3 sets of layers in stage 2 1432 can be defined by 9 depth pixels, 80 height pixels, and 80 width pixels. The third layer output associated with the third set of layers, of the 3 sets of layers can be further defined by the number of feature maps associated with the third layer output associated with the third set of layers, of the 3 sets of layers. In some embodiments, there can be a total of 256 feature maps associated with the third layer output associated with the third set of layers, of the 3 sets of layers.

The process described above, can be applied at each of the remaining stages. That is the processor can execute instructions that cause the processor to operate on the real and imaginary components of the complex valued RF image in stage 2 1432, stage 3 1442, stage 4 1452, and stage 5 1462. The processor can execute instructions associated with modules 1464, 1454, 1444, 1434, and 1424, corresponding to hierarchical feature pyramid 1404, that cause the processor to combine the feature maps associated with the output from stage 5 1462, stage 4 1452, stage 3 1442, stage 2 1432, and stage 1 1422. For instance, the processor can combine features associated with a feature map corresponding to the filtered version of the complex valued radar image 1412, that has been convolved with a 1×1 filter, in stage 1 1422, with features associated with a feature map corresponding to the third layer output associated with the third set of layers, of the 3 sets of layers, that has been convolved with a 1×1 filter, in stage 2 1432. The processor can execute instructions associated with module 1434 to combine the upsampled feature map corresponding to the third layer output associated with the third set of layers, of the 3 sets of layers, that has been convolved with a 1×1 filter, and the feature map corresponding to the filtered version of the complex valued radar image 1412, that has been convolved with a 1×1 filter.

In particular, the processor will upsample the feature map corresponding to the third layer output associated with the third set of layers, of the 3 sets of layers, that has been convolved with a 1×1 filter, in stage 2 1432, so that the number of samples in the upsampled feature map corresponding to the third layer output associated with the third set of layers, of the 3 sets of layers, that has been convolved with a 1×1 filter, is equal to the number of samples in the feature map corresponding to the filtered version of the complex valued radar image 1412, that has been convolved with a 1×1 filter. The processor can then combine the upsampled feature map corresponding to the third layer output associated with the third set of layers, of the 3 sets of layers, that has been convolved with a 1×1 filter, and the feature map corresponding to the filtered version of the complex valued radar image 1412, that has been convolved with a 1×1 filter. The processor combines the upsampled feature map corresponding to the third layer output associated with the third set of layers, of the 3 sets of layers, that has been convolved with a 1×1 filter, and the feature map corresponding to the filtered version of the complex valued radar image 1412, that has been convolved with a 1×1 filter, by adding each element in the upsampled feature map corresponding to the third layer output associated with the third set of layers, that has been convolved with a 1×1 filter, to each element in the feature map corresponding to the filtered version of the complex valued radar image 1412, that has been convolved with a 1×1 filter.

The processor can combine a feature map associated with an output from stage 2 1432, that has been convolved with a 1×1 filter, with a feature map associated with the output from stage 3 1442, that has been convolved with a 1×1 filter, in response to executing instructions associated with module 1444. The processor will, upsample the feature map associated with the output from stage 3 1442, that has been convolved with a 1×1 filter, so that the number of samples in the upsampled feature map associated with the output from stage 3 1442, that has been convolved with a 1×1 filter, is equal to the number of samples in the feature map associated with the output from stage 2 1432, that has been convolved with a 1×1 filter. The processor can then perform an element-by-element wise addition of the elements on the upsampled feature map associated with the 1×1 filtered output from stage 3 1442, that has been convolved with a 1×1 filter, with the elements in the feature map associated with the 1×1 filtered output from stage 2 1432.

The processor can combine a feature map associated with an output from stage 3 1442, that has been convolved with a 1×1 filter, with a feature map associated with the output from stage 4 1452, that has been convolved with a 1×1 filter, in response to executing instructions associated with module 1454. The processor will, upsample the feature map associated with the output from stage 4 1452, that has been convolved with a 1×1 filter, so that the number of samples in the upsampled feature map associated with the output from stage 4 1452, that has been convolved with a 1×1 filter, is equal to the number of samples in the feature map associated with the output from stage 3 1442, that has been convolved with a 1×1 filter. The processor can then perform an element-by-element wise addition of the elements on the upsampled feature map associated with the 1×1 filtered output from stage 4 1452, with the elements in the feature map associated with the 1×1 filtered output from stage 3 1442.

The processor can combine a feature map associated with an output from stage 4 1452, that has been convolved with a 1×1 filter, with a feature map associated with the output from stage 5 1462, that has been convolved with a 1×1 filter, in response to executing instructions associated with module 1464. The processor will, upsample the feature map associated with the output from stage 5 1462, that has been convolved with a 1×1 filter, so that the number of samples in the upsampled feature map associated with the output from stage 5 1462, that has been convolved with a 1×1 filter, is equal to the number of samples in the feature map associated with the output from stage 4 1452, that has been convolved with a 1×1 filter. The processor can then perform an element-by-element wise addition of the elements on the upsampled feature map associated with the 1×1 filtered output from stage 5 1462 with the elements in the feature map associated with the 1×1 filtered output from stage 4 1452.

When the processor executes instructions associated with module 1424, module 1424 will simply input the filtered version of the complex valued radar image 1412, that has been convolved with a 1×1 filter. Module 1424 will then output the filtered version of the complex valued radar image 1412, that has been convolved with a 1×1 filter to module 1426 of the multi-resolution object detector 1406.

Multi-resolution object detector 1406 can include a plurality of modules (modules 1426, 1436, 1446, 1456, and 1466), along with an object proposals module (object proposals 1476), that includes a non-max suppression module (non-max suppression 1486), a score module (score 1496), and a bounding box module (bounding box 1416).

Modules 1426, 1436, 1446, 1456, and 1466 can be executed by the processor to generate feature maps 1424, 1434, 1444, 1454, and 1464 respectively. When the processor executes any of the modules 1426, 1436, 1446, 1456, and 1466, bounding box 1416 and score 1496 can be generated as a result of execution of instructions associated with modules 1426, 1436, 1446, 1456, and 1466. The object proposals associated with each of modules 1426, 1436, 1446, 1456, and 1466, can be combined in response to executing instructions associated with non-max suppression 1486 in order to generate a subset of the total set of object proposals 1426, 1436, 1446, 1456, and 1466. The process of combining the object proposals can be referred to as down-selection via non-max suppression. The feature maps 1424, 1434, 1444, 1454, and 1464 can be extracted at different scales or resolutions.

When the processor executes instructions associated with object proposal module 1476 (Regional Proposal Network (RPN)), the processor can apply one or more sliding windows over a set of multi-resolution feature maps to identify regions of the RF image that are likely to contain an object. Score module 1496 includes instructions that cause the processor to calculate an object likelihood score for each region of the RF image to determine whether the region contains an object or corresponds to a background in the RF image. If the processor determines that the likelihood score is above a threshold, then the processor determines that the region of the RF image contains an object. After the processor determines that the region includes the object, the region that is determined to include the object can be used by the processor to perform a bounding box regression analysis. The bounding box regression analysis can be performed in response to the processor executing instructions associated with detection head 1418.

In some instances, the processor can generate more than one overlapping bounding boxes. In such a situation, the processor executes instructions associated with non-max suppression module 1486, that cause the processor to select only one (an optimal bounding box) around the object, and suppressing or discarding the other bounding boxes. The processor accomplishes this by suppressing or discarding the bounding boxes that have not been associated with a maximum likelihood score. Because the processor generates a likelihood score associated with a certain region, and a bounding box is generated for each region in which the likelihood score is above the threshold, any bounding box that is associated with a region that has a likelihood score that is not equal to the maximum likelihood score can be discarded by the processor. In the event that multiple bounding boxes are generated for the same object category, Non-max suppression 1486 is applied to discard the lowest confidence prediction in the set of overlapping bounding boxes (IoU>0.5). The processor can continue to execute instructions associated with non-max suppression 1486 until the best bounding box is identified. The processor can iteratively execute instructions associated with non-max suppression 1486 until the bounding box with the highest confidence prediction is identified.

The processor can determine the bounding box with the highest confidence by selecting a first bounding box with a first highest confidence of all bounding boxes that overlap with the selected first bounding box. Any bounding boxes that overlap with the first bounding box are discarded and not considered. After the first bounding box with the first highest confidence is selected, a second, or next bounding box with a second, or next highest confidence box of the remaining bounding boxes that have not been discarded is selected. And any bounding boxes that are overlapping with the second highest confidence bounding box, are discarded. The processor can continue to select the highest confidence bounding boxes until there are no bounding boxes left.

Detection Head 1418 can input an output from object proposals module 1476 along with feature maps, and the processor can perform a regression analysis to estimate bounding box coordinates around the detected object, based on these inputs. The instructions associated with object proposals module 1476, can cause the processor to generate one or more proposed object regions corresponding to regions of complex valued radar image 1412 that the processor estimates the object could be within. The proposed object regions have corresponding anchor bounding boxes. The anchor bounding boxes can be a predefined set of boxes (over several scales and aspect ratios) that are used as reference points for the regression analysis.

The anchor boxes can be described as a set of predefined bounding boxes of varied heights and widths that are applied over the original RGB image or RGB-D image. The anchor boxes can be used for reference by a processor in executing the RPN corresponding to module 1476 for predicting the locations of certain objects. There can be two different types of anchor boxes. A first anchor box can be a foreground bounding box which contains the object, or a background bounding box which does not include the object. The processor can utilize anchor boxes to evaluate multiple object predictions at once (i.e. without the need for a sliding window approach over the entire image) which speeds up computation and enables real-time object detection.

The processor generates one or more ground-truth bounding boxes that include a plurality of coordinates (gₓ, g_{y}, gₕ, g_{w}). The coordinate gₓ can be a first coordinate that represents a first physical point on the ground-truth bounding box that corresponds to a first distance from a physical reference point in space along a first axis, and the coordinate g_{y} can be a second coordinate that represents a second physical point on the ground-truth bounding box that corresponds to a second distance from a physical reference point in space along a second axis. The coordinates gₓ and g_{y} can correspond to the center of the ground-truth bounding box. The coordinate gₕ can correspond to a height of the ground-truth bounding box, and the coordinate g_{w} can correspond to a width of the ground-truth bounding box.

The processor also generates one or more predicted bounding boxes that include a plurality of coordinates (pₓ, p_{y}, pₕ, p_{w}). The coordinate pₓ can be a first coordinate that represents a first virtual point on a predicted bounding box that corresponds to a first distance from a first virtual reference point in virtual space along a first axis, and the coordinate p_{y} can be a second coordinate that represents a second virtual point on the predicted bounding box that corresponds to a second distance from a second virtual reference point in space along a second axis. The coordinates pₓ and p_{y} can correspond to the center of the predicted bounding box. The coordinate pₕ can correspond to a height of the predicted bounding box, and the coordinate p_{w} can correspond to a width of the predicted bounding box.

The instructions associated with detection head 1418 cause the processor to learn a scale-invariant transform between the coordinates (pₓ, p_{y}) and (gₓ, g_{y}), (pₕ, gₕ) and (p_{w}, g_{w}). That is, when the processor executes the instructions, the processor is programmed to learn, or determine a scale-invariant transform between coordinates pₓ and gₓ, p_{y} and g_{y}, pₕ and gₕ, and p_{w} and g_{w}. The processor determines the scale-invariant transform between the coordinates by iteratively minimizing the sum of squared errors (SSE) between a per-class correction term coordinates (tₓ, t_{y}, tₕ and t_{w}) and the transform applied to the prediction coordinates (pₓ, p_{y}, pₕ, p_{w}) A class can be defined as the item name or category (e.g., pressure cooker, firearm). In some embodiments, the per-class correction term coordinates can be a function of (pₓ, p_{y}, pₕ, p_{w}) and (gₓ, g_{y}, gₕ, g_{w}). For example, tₓ can be equal to (gₓ−pₓ)/p_{w}, t_{y} can be equal to (g_{y}−p_{y})/pₕ, t_{w} can be equal to log(g_{w}/p_{w}), and tₕ can be equal to log(gₕ/pₕ).

The processor can determine an initial scale-invariant transform with an initial set of parameters, apply the initial scale-invariant transform to the prediction coordinates (pₓ, p_{y}, pₕ, p_{w}), and then determine the SSE between correction term coordinates (tₓ, t_{y}, tₕ and t_{w}) and the prediction coordinates (px, py, ph, pw). The processor can update the initial scale-invariant transform with a new set of parameters, apply the updated scale-invariant transform to the prediction coordinates (pₓ, p_{y}, pₕ, p_{w}), and then determine the SSE between correction term coordinates (tₓ, t_{y}, tₕ and t_{w}) and the updated scale-invariant transform applied to the prediction coordinates (pₓ, p_{y}, pₕ, p_{w}). The processor can continue to update the scale-invariant transform and apply subsequently updated scale-invariant transforms to the prediction coordinates until the SSE between the correction term coordinates and the prediction coordinates is less than a predetermined threshold. At that point, the processor can determine that a regression model for the correction term coordinates has been generated and a scale-invariant transform has been generated that can accurately map the predicted coordinates from the virtual space to the physical space.

The processor can execute instructions associated with Classification Head 1428, and the processor will classify one or more objects, that have been detected by the processor in a RF image, as a result of executing instructions associated detection head 1418. The processor can classify the one or more objects as belonging to one of a plurality of possible output classes and can determine a classification score associated with the one or more objects. The classification score can be a numerical value indicating the likelihood with which the one or more objects detected in the RF image belong to a particular class.

The processor can execute instructions associated with Segmentation Head 1438, and the processor will segment parts of the RF image, associated with the one or more objects that have been detected by the processor, from a background in a RF image. The processor can segment the parts of the RF image, associated with the one or more objects that have been detected by the processor, by identifying pixels that belong to the detected one or more objects that are within a bounding box.

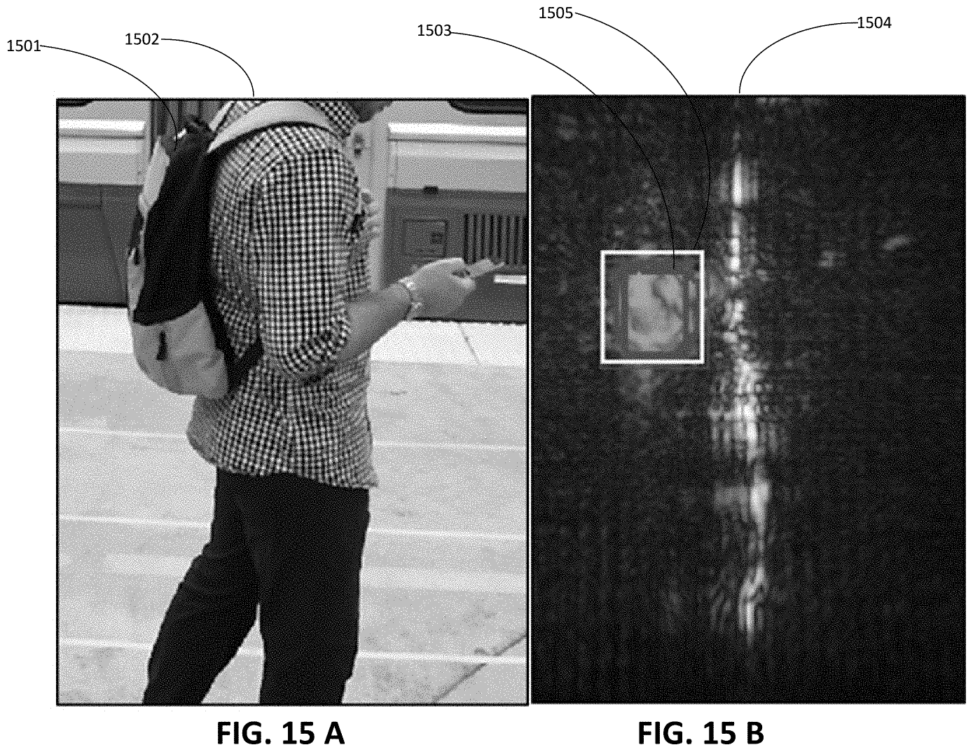

FIG. 15A illustrates a RGB image 1502 of an individual carrying a backpack 1501, FIG. 15B illustrates a RF image 1504 of an individual carrying the backpack 1501. The backpack 1501 can include an object inside that the RF imaging sensor can determine is an object of interest 1503. That is, the GPU can execute the segmentation head instruction set which can cause a GPU to generate a segmentation mask 1504 around the object of interest that is within the backpack 1501. The segmentation mask 1504 can identify pixels that correspond to the object of interest that are within the bounding box 1505. The bounding box 1505 can be generated by the GPU executing the detection head instruction set.

A benefit of the RF object detection architecture instruction set is the ability to train the instruction set to detect things other than an object of interest. For instance, in some embodiments the RF object detection architecture instruction set can be trained to detect particular threat items, but in other embodiments, the RF object detection architecture instruction set can be trained to learn signatures of materials (e.g., metal) rather than named items (e.g., canister made from metal).

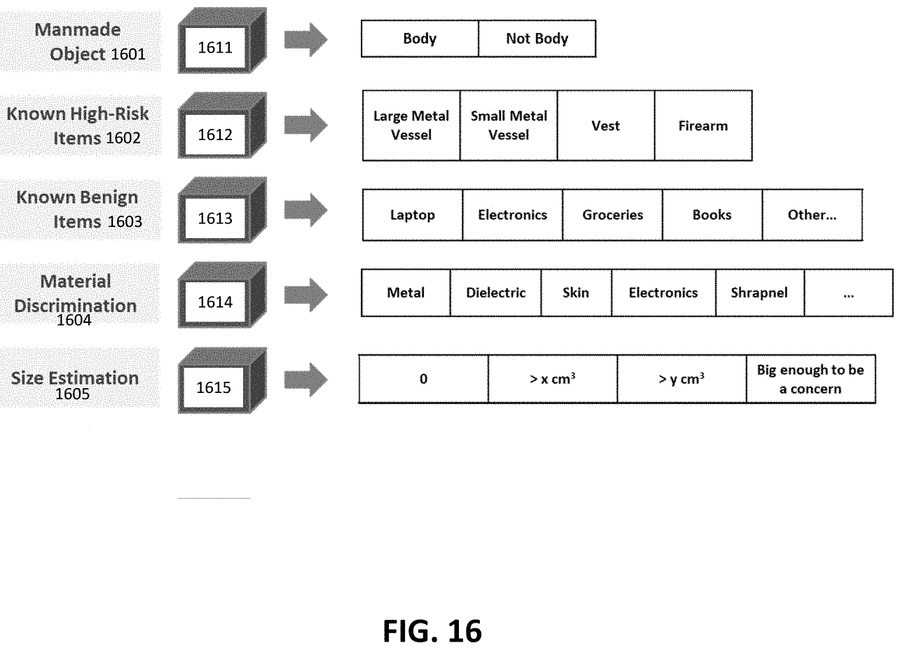

FIG. 16 illustrates other possible tasks, that the RF object detection architecture instruction set can be trained to determine or detect, in response to processing a RF image. In some embodiments, instead of the GPU just determining a concealed object of interest, the GPU can determine whether the object of interest is a manmade object 1601 by executing one or more computer executable instructions that cause the RF object detection architecture instruction set 1611 to learn how to discern between a manmade object and a non-manmade object. For instance, the RF object detection architecture instruction set can be trained to analyze a return RF signal from a scene, and cause a GPU to determine based on the object(s) detected in the RF image that the object(s) correspond to a human body because the RF signal is reflected from human tissue, which would imply that the object(s) are non-manmade. Alternatively, the RF object detection architecture instruction set 1612 can be trained to analyze the return RF signal from the scene, and cause the GPU to determine based on the object(s) detected in the RF image that the object(s) do not correspond to a human body because the RF signal is not reflected from human tissue, and therefore is either a manmade object, or another object of nature (e.g., an animal or plant).

In other embodiments, the GPU can determine whether an object detected in the scene is a known-risk item 1602 by executing one or more computer executable instructions that cause the RF object detection architecture instruction set 1612 to learn how to discern between different types of high-risk items such as large metal vessels, small metal vessels, vests, and/or firearms. Yet in other embodiments, the GPU can also determine whether an object detected in the scene is a benign item 1603 by executing one or more computer executable instructions that cause the RF object detection architecture instruction set 1613 to learn how detect certain benign items such as laptops, personal electronics, groceries, books etc. Yet still in other embodiments, the GPU can also discriminate (material discrimination 1604) between different materials that a detected object in the scene is made out of, by executing one or more computer executable instructions that cause the RF object detection architecture instruction set 1614 to learn how to discriminate between different types of materials. For instance the RF object detection architecture instruction set can contain specific instruction sets that cause the GPU to discriminate between an object that is made of metal versus an object made of dielectric material, skin, electronics, and/or shrapnel. Yet still in other embodiments, the GPU can also determine a size of the object (size estimation 1605) in the scene, by executing one or more computer executable instructions that cause the RF object detection architecture instruction set 1615 to learn how to estimate the size or dimensions of the object in the scene. For instance the GPU be able to determine that the object is a negligible size and not worth alerting a user to the presence of the object (e.g., this can correspond to the number 0), or determine that the volume of the object is greater than a certain number of cubic centimeters (e.g., greater than x cm³ or y cm³), or determine that the volume of the object exceeds a threshold that can cause the GPU to generate an alert to an operator of the imaging sensor system.

As described herein, embodiments of the image sensor system can provide for co-locating the RF imaging sensor with the RGB/RGB-D camera, or sensor, in order provide important contextual information to support automated threat detection in RF imagery. By pairing a collocated RF imaging sensor with a RGB/RGB-D camera, or sensor, it is possible to extract information about people and objects in the scene using computer vision techniques. This can be accomplished by segmenting a scene in a RF image into objects (e.g., people, carried bags, suitcases, and/or other accessories that are commonly carried by people) in a scene of a RGB/RGB-D image, and then analyzing portions of the RF image that coincide with the objects detected and identified in the RGB/RGB-D image. The process of segmenting the RGB/RGB-D image can be referred to as generating a segmentation “map” of where the objects are located in the scene.

Because the map can provide detailed information about where an individual is, and body parts of the individual can automatically be detected and identified, a processor can apply privacy preserving data analytic products, such as image overlays that mask sensitive regions of the body of the individual. For example, an individual's head can be temporarily masked (e.g., blurred) so that it is not visible to an operator of the imaging sensor system. If the processor determines that the individual is carrying object, that is suspicious or could potentially be a threat based on the map and the corresponding portion of the RF image where the object was detected, the mask can be removed.

The map can also be used by the GPU to perform adaptive detection based on what object has been detected in the scene, and possibly where the object has been detected in the scene. For example, the GPU can use the map to determine if an individual is carrying a large object such as a suitcase, backpack, tripod cases, or any other large object and can determine that a portion of a RF image corresponding to the location in the scene where the large object is detected should be analyzed to determine the contents of the large object. The GPU can further determine the location of where the object is detected relative to other objects in the scene of the RF image, which could also cause the GPU to analyze the corresponding portion of the RF image where the detected object is. For example, if the detected object is a large suitcase or several tripod cases that have been left on the ground of a large open space, that is heavily trafficked with people, the GPU, or another processor, can display the corresponding RF image on a screen to the operator for further analysis.

The map can also be used to quantify, or determine, how much of the scene was not imaged due to an occlusion or shadow. For example, if a portion of the scene is occluded by another object, or a shadow is cast by another object onto a portion of the scene, the GPU or processor can generate a metric that indicates whether portions of the scene were not imaged due to the occlusion or shadow.

As an example, if an object is detected in the scene according to a RGB-D sensor, but there is little to no RF signal in the region corresponding to a radar image of the scene, then the object could be in a shadow even though the sensor has line-of-sight to the object. The metric can be based on the detection of the object in the scene by the RGB-D sensor, and a strength of one or more return signals reflected from the object, in response to the transmission of one or more RF signals from one or more panel arrays. For instance, the metric could be a Received Signal Strength Indicator (RSSI) associated with the one or more return signals when an object is detected by the RGB-D sensor. When the RSSI is below a certain RSSI threshold, the effectiveness of the threat detection can be diminished because the scene is not properly imaged by the RF sensor.

Prior to the segmentation, the GPU can first detect an object of interest and then classify the object of interest in the RGB/RGB-D image. In addition to this, the GPU can analyze the RGB/RGB-D image to determine the pose of an individual, by determining the location of a set of keypoints corresponding to specific locations on the body.

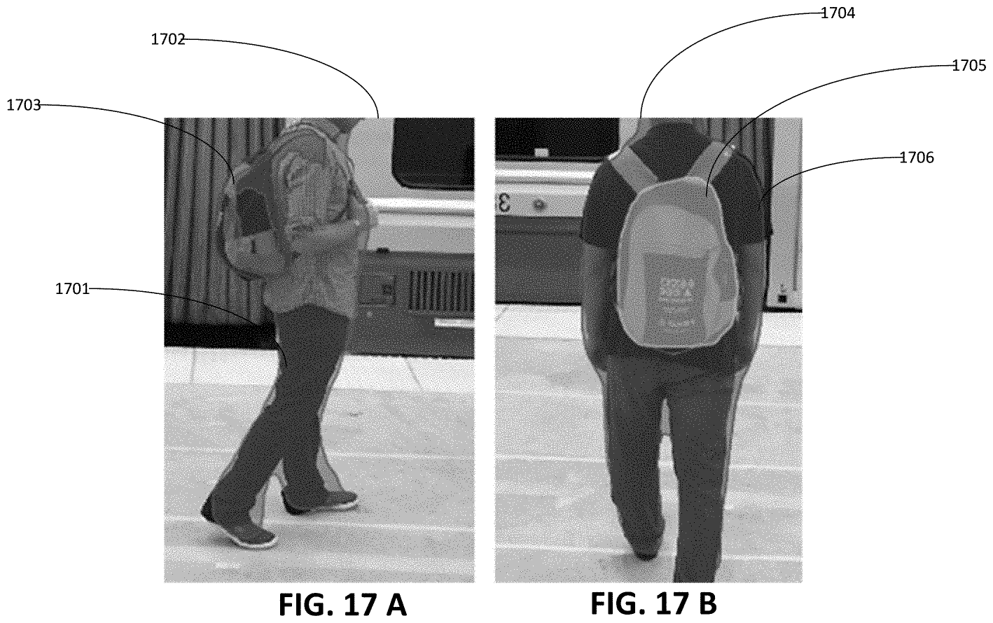

FIG. 17A illustrates a RGB-D image 1702 of an individual 1701 from a side view. The individual 1701 is carrying a backpack 1703. In the RGB-D image 1702, the GPU has detected the presence of a human being (individual 1701) and applied a blue mask around the image of individual 1701. The GPU has also detected the presence of an object (backpack 1703) that is not a part of the individual 1701, and therefore determines that the object is not a part of the individual 1701 and applies a red mask around the backpack 1703. Prior to applying the mask to backpack 1703 however, the GPU can first determine that the object is a backpack, and second classify it as a backpack. The GPU can classify objects in to a plurality of classes including, but not limited to backpacks, carried bags (handbags, messenger bags, grocery bags), briefcases, and suitcases.

FIG. 17B illustrates another RGB-D image 1704 that includes a rear facing view of an individual 1706 carrying a backpack 1705. The GPU detects the presence of the individual 1706 and applies a red mask around the image of 1706. In some embodiments, the GPU can apply a different color mask to different individuals and the objects they are carrying.

Another aspect of the analysis of an RGB/RGB-D image is the identification of the pose of the individual as well. The ability to determine the pose of an individual could be particularly important in situations where parts of the individual's body are oriented in such a way that it might suggest that the individual is carrying an object in a bag or on their person that might be of interest. For instance, if an individual appears to be hunched over and in a sequence of RGB/RGB-D images it appears as though the individual is laboring to carry a bag (e.g., backpack or other medium to large size object) that could contain an item of interest, or potentially threating item, the GPU can determine based on the pose(s) of the individual across the different RGB/RGB-D images, that the contents of the individual's bag should be analyzed. As an example, the individual could be carrying a pressure cooker explosive device that includes large heavy pieces of shrapnel, thereby causing the individual to hunch over when they might otherwise not be carrying a bag of the same size. In response to determining the pose of the individual across the RGB/RGB-D images the GPU can then analyze a corresponding portion of a RF image associated with the scene, in order to determine the contents of the individual's bag.

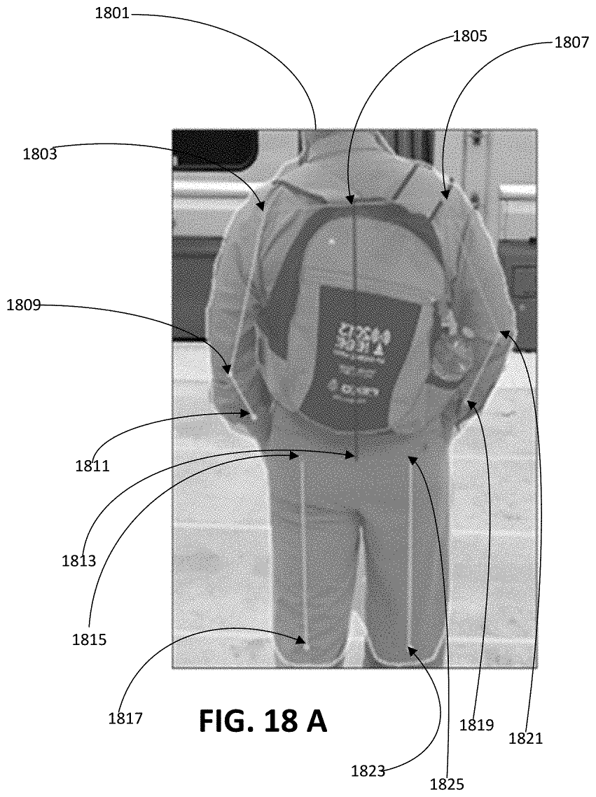

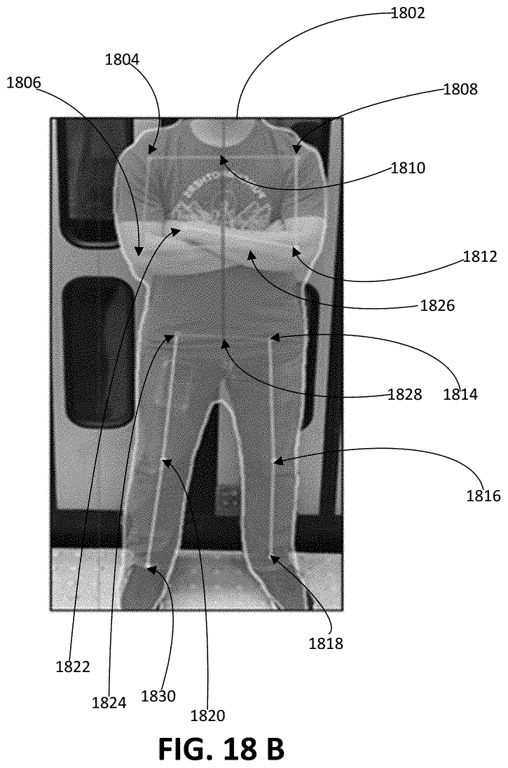

The poses can be determined based on a plurality of keypoints at certain positions of corresponding to joints in the body where portions of an appendages connected to one another. For example, the GPU can place one or more keypoints in certain positions in a RGB/RGB-D image that correspond to a knee, wrist, elbow, hip, shoulder, and/or ankle, on an individual detected in the RGB/RGB-D image. As shown in FIG. 18, there can be a plurality of keypoints added to a RGB/RGB-D image corresponding to different joints of points of connection between different parts of an individual's body.

In the RGB-D image 1801, there can be a plurality of keypoints associated with the anatomy of the individual. For example, a keypoint 1803 can correspond to the left shoulder of the individual and a keypoint 1807 can correspond to the right shoulder of the individual. A keypoint 1809 can correspond to the left elbow of the individual, and a keypoint 1821 can correspond to the right elbow of the individual. A keypoint 1811 can correspond to the left wrist of the individual and a keypoint 1819 can correspond to the right wrist of the individual. A keypoint 1815 can correspond to the left hip of the individual, and a keypoint 1825 can correspond to the right hip of the individual. A keypoint 1817 can correspond to the left knee of the individual, and a keypoint 1823 can correspond to the right knee of the individual. A keypoint 1805 can correspond to the top of the spine of the individual, and a keypoint 1813 can correspond to the bottom of the spine of the individual.

There can be a plurality of lines connecting one or more of the keypoints, which results in providing a skeletal outline of the individual. For example, a line can connect the keypoint 1803 and the keypoint 1807, which can correspond to a distance between the individual's left and right shoulder. There can be a line connecting the keypoint 1803 and the keypoint 1809, which can correspond to a distance between the individual's left shoulder and left elbow. There can be a line connecting the keypoint 1809 and the keypoint 1811, which can correspond to a distance between the individual's left elbow and left wrist. There can be a line connecting the keypoint 1815 and the keypoint 1817, that can correspond to a distance between the individual's left hip and left knee.

There can also be a line connecting the keypoint 1805 and the keypoint 1813, which can correspond to a length of the individual's spine. There can be a line connecting the keypoint 1807 and the keypoint 1821, which can correspond to a distance between the individual's right shoulder and right elbow. There can be a line connecting the keypoint 1821 and the keypoint 1819, which can correspond to a distance between the individual's right elbow and right wrist. There can be a line between the keypoint 1825 and the keypoint 1823, which can correspond to a distance between the right hip of the individual and the right knee of the individual.

In the RGB image 1802, there can be a plurality of keypoints associated with the anatomy of the individual. For example, a keypoint 1808 can correspond to the left shoulder of the individual and a keypoint 1804 can correspond to the right shoulder of the individual. A keypoint 1812 can correspond to the left elbow of the individual, and a keypoint 1806 can correspond to the right elbow of the individual. A keypoint 1822 can correspond to the left wrist of the individual and a keypoint 1826 can correspond to the right wrist of the individual. A keypoint 1814 can correspond to the left hip of the individual, and a keypoint 1824 can correspond to the right hip of the individual. A keypoint 1816 can correspond to the left knee of the individual, and a keypoint 1820 can correspond to the right knee of the individual. A keypoint 1810 can correspond to the top of the spine of the individual, and a keypoint 1828 can correspond to the bottom of the spine of the individual.

There can be a plurality of lines connecting one or more of the keypoints, which results in providing a skeletal outline of the individual. For example, a line can connect the keypoint 1804 and the keypoint 1808, which can correspond to a distance between the individual's left and right shoulder. There can be a line connecting the keypoint 1808 and the keypoint 1812, which can correspond to a distance between the individual's left shoulder and left elbow. There can be a line connecting the keypoint 1822 and the keypoint 1812, which can correspond to a distance between the individual's left elbow and left wrist. There can be a line connecting the keypoint 1814 and the keypoint 1816, that can correspond to a distance between the individual's left hip and left knee.

There can also be a line connecting the keypoint 1810 and the keypoint 1828, which can correspond to the length of the individual's spine. There can be a line connecting the keypoint 1804 and the keypoint 1806, which can correspond to a distance between the individual's right shoulder and right elbow. There can be a line connecting the keypoint 1806 and the keypoint 1826, which can correspond to a distance between the individual's right elbow and right wrist. There can be a line between the keypoint 1824 and the keypoint 1820, which can correspond to a distance between the right hip of the individual and the right knee of the individual. There can a line between the keypoint 1820 and a keypoint 1830, which can correspond to a distance between the right knee and the right ankle of the individual. There can also be a line between the keypoint 1816 and a keypoint 1818, which can correspond to the distance between the left knee and left ankle of the individual.

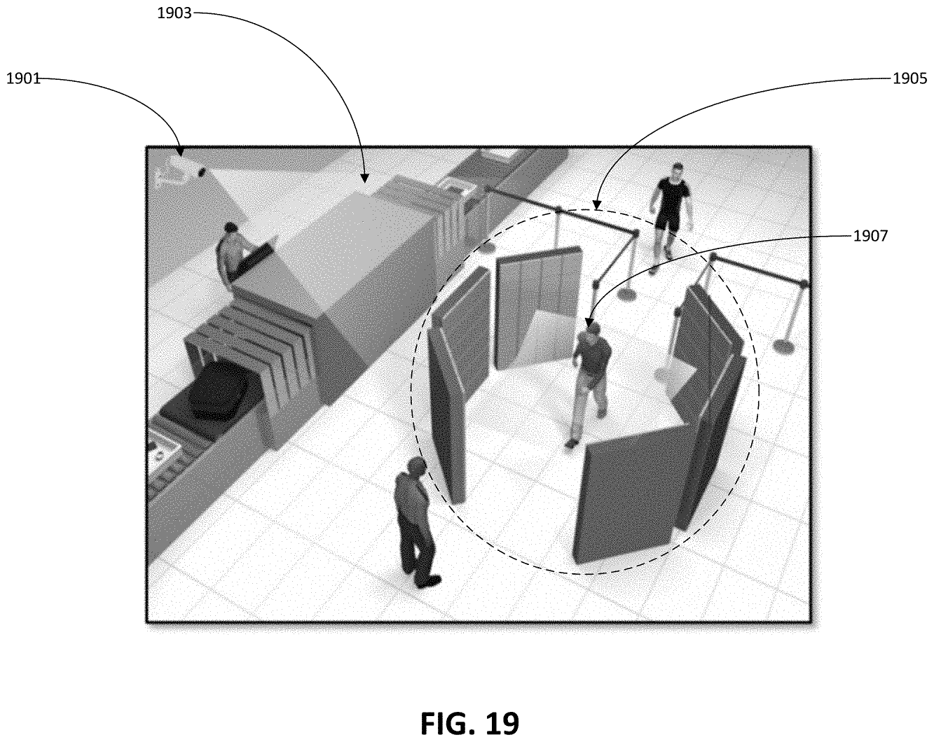

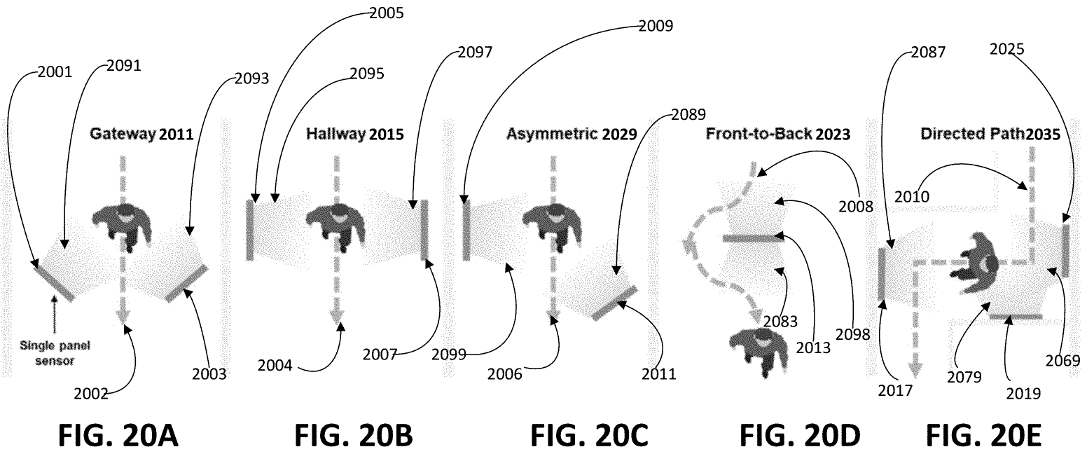

Traditional airport portal-based screening systems can only image about 50% of a person from a single panel at any one time. RF imagers however capture the scene much like a video camera, and by collecting data from multiple panels simultaneously, from varied viewpoints, can provide comprehensive screening of a subject. In some embodiments, there can be a plurality of panel arrays, much like panel array 402, that can be positioned in such a way to capture RF images on every side of the individual, as illustrated in FIG. 19 and FIG. 20. These configurations provide a diverse set of views of one or more subjects.

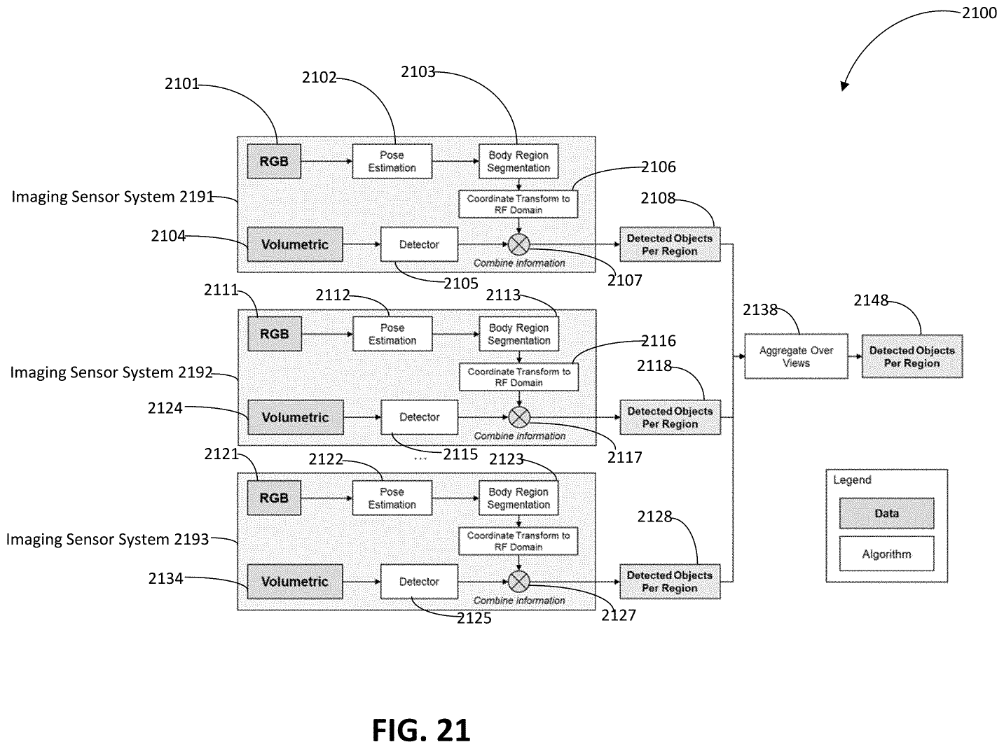

FIG. 19 illustrates a scene of an individual 1907 walking through a plurality of a multi-view RF imaging sensor system 1905 comprising a plurality of panel arrays that are situated on either side of the individual as they walk through a 360 degree field of view of the multi-view RF imaging sensor system 1905. The multi-view RF imaging sensor system 1905 can be accompanied by RGB/RGB-D camera 1901, with a RGB/RGB-D field of view 1903 that the individual walks through at the same time the individual is being imaged by the plurality of panel arrays 1905. The RF images generated by the multi-view RF imaging sensor system 1905 can be used along with RGB/RGB-D images generated by the RGB/RGB-D camera 1901, by the GPU to analyze objects and subjects in scene from a plurality of different viewpoints. Each of the RF images and corresponding RGB/RGB-D images can be analyzed individually per each viewpoint, and can be fused together to detect concealed objects. The details regarding the fusion of RF images and corresponding RGB/RGB-D images are provided below, with respect to FIG. 21.

FIGS. 20A-E illustrate different configurations of panel arrays that are positioned in certain ways to provide different RF image viewpoints.

FIG. 20A illustrates a RF imaging sensor of an embodiment of the imaging sensor system with two RF imaging sensors disposed at ninety degrees relative to each other to illuminate a field of view of an individual at approximately a 45 degree angle with respect to the individual's direction of movement, in accordance with exemplary embodiments of the present disclosure. For example, FIG. 20A illustrates a gateway 2011 with an panel array orientation in which a right angled panel array 2003 and a left angled panel array 2001 illuminate an overlapping field of view through which the individual walks.

The face of the right angled panel array 2003 forms a 45 degree angle with the line 2002 which represent the direction of movement of the individual. The face of the right angled panel array 2003 corresponds to the side of right angled panel array 2003 in which one or more transmit elements in the right angled panel array 2003 illuminate the left side of the individual in a field of view 2093. The face of the left angled panel array 2001 forms a 45 degree angle with the line 2002. The face of the left angled panel array 2001 corresponds to the side of left angled panel array 2001 in which one on more transmit elements in the left angled panel array 2001 illuminate the right side of the individual in a field of view 2091.

The right angled panel array 2003 generates a first RF image and the left angled panel array 2001 generates a second RF image, and the first RF image and the second RF image can be fused tougher to provide a multi-view RF image. Gateway 2011 corresponds to an panel array orientation in which the left front portion and right front portion of the individual can be imaged.

FIG. 20B illustrates a RF imaging sensor of an embodiment of the imaging sensor system with two RF imaging sensors opposing spaced from each other to illuminate the left and right hand side of an individual, at a 90 degree angle with respect to the individual's direction of movement, in accordance with exemplary embodiments of the present disclosure. For example, FIG. 20B illustrates a hallway 2015 with an panel array orientation in which a first panel array images a right side of the individual and a second panel array images a left side of the individual as the individual walks between the two panel arrays.

Panel array 2005 and panel array 2007 can illuminate an overlapping field of view in which the right side and the left side of the field of view of the individual can be imaged. The face of the panel array 2007 is parallel to the line, but the direction of illumination forms a 90 degree angle with the line 2004. The face of the panel array 2007 corresponds to the side of panel array 2007 in which one or more transmit elements in the panel array 2007 illuminates the left side of the individual in a field of view 2097. The face of the panel array 2005 is parallel to the line, but the direction of illumination forms a 90 degree angle with the line 2004. The face of the panel array 2005 corresponds to the side of panel array 2005 in which one on more transmit elements in the panel array 2005 illuminates the right side of the individual in a field of view 2095. The face of panel array 2097 faces the face of the panel array 2095.

The panel array 2005 generates a first RF image corresponding to the right side of the individual, and the panel array 2007 generates a second RF image corresponding to the left side of the individual. In this orientation, the first RF image and the second RF image can be fused together to detect objects that can be located on either side of the individual, and/or behind or in front of the individual. Because the RF images correspond to profile views of the individual, the RF images can analyzed by the one or more processors of the imaging sensor system to detect objects that are in the bag and/or concealed and secured to the body of the individual.

FIG. 20C illustrates a RF imaging sensor of an embodiment of the imaging sensor system with two RF imaging sensors, with one RF imaging sensor illuminating a portion of an individual at a 90 angle with respect to the individual's direction of movement, and another RF imaging sensor illuminating another portion of the individual at a 45 degree angle with respect to the individual's direction of movement, in accordance with exemplary embodiments of the present disclosure.

For example, FIG. 20C illustrates an asymmetric panel array arrangement 2029 in which a first panel array is oriented to image the right side of the individual, and a second panel array is oriented to image the left front portion of the individual. Panel array 2009 and panel array 2011 can separately illuminate two fields of view that can or might not overlap.

The face of the panel array 2011 forms a 45 degree angle with the line 2006. The face of the panel array 2011 corresponds to the side of the panel array 2011 in which one or more transmit elements in the panel array 2011 illuminate the left side of the individual in a field of view 2089. The panel array 2009 can illuminate the right-hand side of the individual as the individual traverses line 2006.

The face of the panel array 2009 is parallel to the line, but the direction of illumination forms a 90 degree angle with the line 2006. The face of the panel array 2009 corresponds to the side of the panel array 2009 in which one on more transmit elements in the panel array 2009 illuminates the right side of the individual in a field of view 2099. The panel array 2011 can illuminate the left-front side of the individual as the individual traverses line 2006.

FIG. 20D illustrates a double sided RF imaging sensor (e.g., a pair of panel arrays disposed back to back to illuminate fields of view in opposite directions) of an embodiment of the imaging sensor system illuminating the backside of an individual as they walk away from the RF imaging sensor, and illuminating the front side of the individual as the walk towards the RF imaging sensor, in accordance with exemplary embodiments of the present disclosure.

For example, FIG. 20D illustrates a front-to-back panel array arrangement 2023 in which a first panel array faces towards a first direction, e.g., to capture RF images of the front of the individual as the individual walks toward the first panel array, and a second panel array is disposed adjacent to the first panel array, but faces away from the first panel array to illuminate a field of view that is 180 degrees in the opposite direction of the field of view of the first panel array, e.g. to capture RF images of the back of the individual as the individual walks away from the second panel array. The first panel array and the second panel array can be adjoined to a fixed structure 2013.

The fixed structure 2013 can include one or more transmit elements that illuminates the individual in a field of view 2098 as the individual traverses curve 2008 and approaches the fixed structure 2013. These one or more transmit elements can illuminate the front of the individual. The fixed structure 2013 can also include one or more transmit elements that illuminates the individual in a field of view 2083 is the individual traverses curve 2008 as walks away from the fixed structure.

FIG. 20E illustrates a RF imaging sensor system of an embodiment of the imaging sensor system including three RF imaging sensors illuminating various portions of an individual as they walk through the RF imaging sensor system, in accordance with exemplary embodiments of the present disclosure.

For example, FIG. 20E illustrates a directed path panel array arrangement 2035 panel array in which the panel arrays are positioned and oriented to illuminate multiple overlapping fields of view as an individual traverse a directed path such as for example in a security screening area of an airport. The left side of the individual is illuminated by the panel 2025 at the same time the front of the individual is illuminated by the panel 2019. The field of view 2019 and the field of view 2069 can overlap.

After the individual turns to their right to follow the directed path, the front of the individual is illuminated by the panel array 2017 while the left side of the individual is illuminated by the panel array 2019, and the back of the individual is illuminated by the panel array 2025, where the panels 2017, 2019, and 2025 can be simultaneously illuminate the individual. The field of view 2087 can overlap with the field of view 2079 and the field of view 2069. In some embodiments, the field of view 2087, will not overlap with the field of view 2079 and the field of view 2069. After the individual turns to their left to continue following the directed path 2010, the right side of the individual is illuminated by the panel array 2017. As the individual traverses the directed path 2010, RF images of different portions of the individual are generated by the panel arrays 2017, 2019, and 2025 thereby allowing the processor to generate a fused three dimensional RF image of the individual over time.

The RF images generated by different panel arrays can be aggregated by first having each RF image processed by the processor independently, and then fusing the processed, and/or analyzed, RF images together. Any objects that are detected in the RF images are aggregated across all of the different viewpoints corresponding to the different panel arrays. For example, if panel array 2025 first detects an object concealed under the individual's shirt or jacket from the left side of the individual while panel array 2019 simultaneously detects the object, the processor can aggregate the RF images corresponding to each of the panel arrays and output a fused 3-D image of the individual and object.

The processor of an embodiment of the imaging sensor system can leverage the fused 3-D image to detect and classify objects that otherwise might go undetected. For instance, the processor (e.g., a GPU) can utilize training data that is based on one or more RF images, of an object, corresponding to a first panel array oriented in a first angle relative to the object, in order to detect the same object by a second panel array that is oriented in a second angle relative to the object, even if there are no RF images corresponding to the object that have been captured by the second panel array. For example, the processor can detect and classify an object when a first surface of the object is detected, but might not be able to detect and classify the object when a second surface of the object is detected. That is to say, there can be a scenario in which the processor detects the object based on one or more RF images corresponding to the illumination of the object, by the first panel array associated with the first surface and the first angle of the first panel array. If the processor is able to correctly detect and classify the object in a first RF image associated with a first panel array and a first corresponding field of view of the object, the processor can correctly detect and classify the object in a second RF image that is associated with a second panel array and a second corresponding field of view of the object. This processor can utilize a correct detection and classification of an object from a first field of view to correctly detect and classify the object from a second field of view.

In order to fuse RF images corresponding to multiple RF imaging sensors, the processor can segment a detected body in a RGB/RGB-D image into smaller regions, such as for instance an “upper left arm,” or “right calf” using the keypoints generated during the estimation of a pose of the individual. For instance, the processor can segment a RGB/RGB-D image in accordance with the segmentation of the individual in RGB image 1802 in FIG. 18. The processor can then project the segmentation boundary of each region into a RF image domain via a three-dimensional coordinate transform. After the processor projects, or aligns each region of the body in the RGB/RGB-D image with the corresponding region of the body in the RF image, the processor assigns any detected objects in the corresponding RF image to a particular region on the body of the individual.

In some embodiments, the detection of objects can be aggregated over the fields of view captured by the RF imaging sensors by applying a weighting function to each output score. In other embodiments, the processor can determine the highest score across all fields of view, in which the processor determines a region of the body at which the object is detected, and then assigns the detected object to the region of the body that has the highest score.

The output score 1496 is a likelihood score that a detected object corresponds to an object of interest. The output score 1496 can be a based on a measure of 1 (i.e., the score is within a range of 0-1). As an example, in a first field of view, the processor can determine a first output score of the object, based on one or more first RF images corresponding to the first field of view, and the processor can further determine a second output score of the object, based on one or more second RF images corresponding to a second field of view. The processor can then determine an average of the two output scores. In some embodiments, a weight can be applied to each of the output scores, and the two resulting values can be added together.

Embodiments of the imaging sensor system can use logic to determine sufficient line-of-sight and imaging quality has been implemented to allow for more complex weighting functions. FIG. 21 illustrates an embodiment of the multi-view imaging sensor system for aggregating objects that have been detected across multiple views, or multiple imaging sensor systems (e.g., imaging sensor system 2191, imaging sensor system 2192, and imaging sensor system 2193). In some embodiments, one or more of the multiple imaging sensor systems can detect a single object from different angles, or different views, where each of the different angles, or views, corresponds to one of the multiple imaging sensor system. In other embodiments, one or more of the multiple imagining sensor systems, can detect different objects. For instance, a first set of the multiple imaging sensor systems, can detect a first object, and a second set of the multiple imaging sensor systems, can detected a second object, and aggregate imaging sensor system 2100 can output the first and second detected object as one or more fused RF images.

In some embodiments, the processor can apply a weighting function in which the output score is multiplied by a value that is proportional to the quality of a RF image. For example, in a situation in which an object is imaged from multiple fields of view, the fields of view that generate an RF image of the object that are not sufficiently imaged, or have a limited line-of-sight to the RF imaging sensor, the processor can apply a weight to the output score of the image for that field of view that is less than a weight applied to an output score associated with a field of view in which there is a clear line of sight and good RF illumination between the RF imaging sensor and the object. Line-of-sight can be determined by the processor based on the RGB-D image data, and RF image quality can be a function of a magnitude and variance of a signal associated with the RF image across a particular region of the image in which the object is detected.

Embodiments of the multi-view imaging sensor system can improve the probability of detection and reduce false alarm rates, when at least two fields of view are combined. In some embodiments, a synthetic multi-view fusion module can be created over time when a single imaging sensor system collects RF images and RGB/RGB-D images across a plurality of fields of view. For instance, a first imaging sensor system can be oriented in a plurality of different ways in order to capture RF images and RGB/RGB-D images that correspond to different fields of view of a given scene. For instance, the first imaging sensor system can be positioned, or oriented, such that the RF imaging sensor of the first imaging sensor system illuminates a first field of view from a first angle in which the ventral side of an individual and any objects being carried by the individual are illuminated, during a first period of time. During a second period of time, the first imaging sensor system can be positioned, or oriented such that the RF imaging sensor of the first imaging sensor system illuminates a second field of view from a second angle in which the left side of the individual and any of the objects being carried by the individual are illuminated. Because embodiments of the imaging sensor systems disclosed herein can be mobile, RF images and RGB/RGB-D images can be collected over a plurality of periods of time in order create a synthetic multi-view imaging sensor system similar to multi-view imaging sensor system 2100. Instead of there being a plurality of imaging sensor systems capturing RF images and RGB/RGB-D images from static angles, one or more imaging sensor systems can be mobilized to create a plurality of views each of which corresponds to a different angle.

The multi-view fusion module 2100 can include (N) different imaging sensor systems. In some embodiments, there can be a single processor that processes the RF images and RGB/RGB-D images generated per view (i.e., imaging sensor systems 2191, 2192, and 2193). In other embodiments, there can be multiple processors that process the RF images and RGB/RGB-D images generated across the different views. For instance, there could be three processors (e.g., GPUs) for a total of nine imaging sensor systems.

Imaging sensor system 2191 can include a RGB camera 2101. RGB camera 2101 can capture a plurality of RGB images, or RGB video footage, in a first field of view corresponding to a scene from a first angle. One or more of the processors can process the RGB images, or RGB video footage, and estimate a pose (pose estimation 2102) of any individuals in the scene in accordance with the pose estimation process described above. One or more of the processors can determine certain regions of the body of the individual (e.g., head region, torso region, forearm region of the arm, calve region of the leg, hand region, foot region, thigh and hamstring region of the leg, and/or bicep and triceps region of the arm) and segment these regions of the body in the RGB images, or RGB video footage, based on the estimated poses, using a body region segmentation process 2103, as described herein.

At the same time, a RF imaging sensor, or volumetric sensor (volumetric 2104) can illuminate the scene and receive one or more return signals from the individual and/or objects in the scene (in plain sight or concealed on the person of the individual) and generate a volumetric images (RF images), corresponding to the first angle. One or more of the processors can then detect any objects in the scene in response to one or more of the processors executing instructions in accordance with detector 2105. The instructions correspond to the detection head described in the RF object detection architecture illustrated in FIG. 14 After one or more of the processors segment the different regions of the body of the individual in the RGB images, or RGB video footage, the processor(s) can execute instructions that cause the processor(s) to transform the RGB images, or RGB video footage, to the volumetric or RF domain (coordinate transform to RF domain 2106). The transformation of the RGB images, or RGB video footage, to the RF/volumetric domain is a process by which one or more of the processors align the RGB images, or RGB video footage, with a corresponding RF images, or RF video footage.

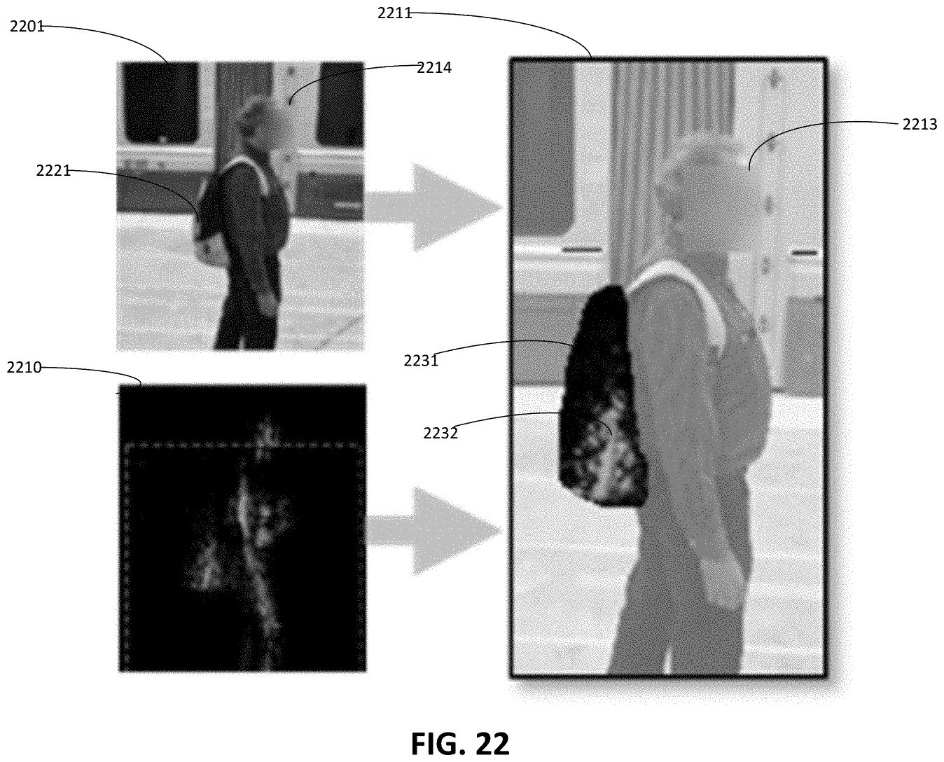

One or more of the processors can then combine the RGB images, or RGB video footage, with RF images, or RF video footage, by executing a combine information instruction set (combine information 2107) the details of which are included below with respect to FIG. 22. One or more of the processors can then determine which regions of the body any objects can be on or next to, by executing the detected objects per region 2108 instruction set.

Imaging sensor system 2192 can include a RGB camera 2111. RGB camera 2111 can capture a plurality of RGB images, or RGB video footage, in a second field of view corresponding to a scene from a second angle. One or more processors (e.g., GPUs) can process the RGB images, or RGB video footage, and estimate a pose (pose estimation 2112) of any individuals in the scene in accordance with the pose estimation process described above. One or more of the processors can determine certain regions of the body of the individual (e.g., head region, torso region, forearm region of the arm, calve region of the leg, hand region, foot region, thigh and hamstring region of the leg, and/or bicep and triceps region of the arm) and segment these regions of the body in the RGB images, or RGB video footage, based on the estimated poses, using a body region segmentation process 2113. The body region segmentation process 2113 is described above.

At the same time, a RF imaging sensor, or volumetric sensor (volumetric 2124) can illuminate the scene and receive one or more return signals from the individual and/or objects in the scene (in plain sight or concealed on the person of the individual) and generate a volumetric images (RF images), corresponding to the second angle. One or more of the processors can then detect any objects in the scene in response to one or more of the processors executing instructions in accordance with detector 2115. The instructions correspond to the detection head described in the RF object detection architecture illustrated in FIG. 14 After one or more of the processors segment the different regions of the body of the individual in the RGB images, or RGB video footage, one or more of the processors can execute instructions that cause one or more of the processors to transform the RGB images, or RGB video footage, to the volumetric or RF domain (coordinate transform to RF domain 2116). The transformation of the RGB images, or RGB video footage, to the RF/volumetric domain is a process by which one or more of the processors align the RGB images, or RGB video footage, with a corresponding RF images, or RF video footage.

One or more of the processors can then combine the RGB images, or RGB video footage, with RF images, or RF video footage, by executing a combine information instruction set (combine information 2117) the details of which are included below with respect to FIG. 22. One or more of the processors can then determine which regions of the body any objects can be on or next to, by executing the detected objects per region 2118 instruction set.

Imaging sensor system 2193 can include a RGB camera 2121. RGB camera 2121 can capture a plurality of RGB images, or RGB video footage, in a n^{th} field of view corresponding to a scene from a n^{th} angle. One or more processors can process the RGB images, or RGB video footage, and estimate a pose (pose estimation 2122) of any individuals in the scene in accordance with the pose estimation process described above. One or more of the processors can determine certain regions of the body of the individual (e.g., head region, torso region, forearm region of the arm, calve region of the leg, hand region, foot region, thigh and hamstring region of the leg, and/or bicep and triceps region of the arm) and segment these regions of the body in the RGB images, or RGB video footage, based on the estimated poses, using a body region segmentation process 2123, as described herein.

At the same time, a RF imaging sensor, or volumetric sensor (volumetric 2134) can illuminate the scene and receive one or more return signals from the individual and/or objects in the scene (in plain sight or concealed on the person of the individual) and generate a volumetric images (RF images), corresponding to the n^{th} angle. One or more processors can then detect any objects in the scene in response to one or more of the processors executing instructions in accordance with detector 2125. The instructions correspond to the detection head described in the RF object detection architecture illustrated in FIG. 14. After one or more of the processors segment the different regions of the body of the individual in the RGB images, or RGB video footage, one or more of the processors can execute instructions that cause one or more of the processors to transform the RGB images, or RGB video footage, to the volumetric or RF domain (coordinate transform to RF domain 2126). The transformation of the RGB images, or RGB video footage, to the RF/volumetric domain is a process by which the GPU aligns the RGB images, or RGB video footage, with a corresponding RF images, or RF video footage.

One or more of the processors can then combine the RGB images, or RGB video footage, with RF images, or RF video footage, by executing a combine information instruction set (combine information 2127) the details of which are included below with respect to FIG. 22. One or more of the processors can then determine which regions of the body any objects can be on or next to, by executing the detected objects per region 2128 instruction set.

One or more of the processors can aggregate detected objects per region 2148 across the N different angles, and the corresponding fields of view, in response to executing the aggregate over views 2138 instructions. After executing the aggregate over views 2138, one or more processors can determine a region of the body where one or more objects were detected based on the aggregated detected objects per region. For example, one or more of the processors can determine that an object of interest is on the right thigh of an individual based on a certain percentage of the detected objects per region indicating that the object is on the right thigh of the individual. For instance, one or more of the processors can determine that the object is on the right thigh of the individual because the detected objects per region for five of the seven total views indicate that the object is on the individual's right thigh.

The color imagery of RGB images and the volumetric RF images can be combined to produce fused visualizations which provide information to security personnel while preserving privacy. For instance, a data product, or fused visualizations, can be created to show the contents of a person's bag or on-body manmade item without revealing imagery of the person's body. FIG. 22 illustrates a side profile fusion of a RF image 2210 of a scene including an individual and RGB image 2201 of the same scene. Data associated with the RGB image 2201 generated by a RGB camera, and data associated with the RF image 2210 generated by a RF sensor, are aligned and fused to show the RF image only within the boundaries of the individual's backpack. The individual's face in the RGB image 2201 is blurred 2214. The fused image 2211 includes a RF image 2232 corresponding to an object detected in the individual's backpack 2221. The RF image 2232 corresponds to the teal-blue image in the RF image 2210. The teal-blue image in the RF image 2210 corresponds to the object detected by a RF imaging sensor. The fused image 2211 also includes a segmentation mask 2231 corresponding to the backpack 2221, to indicate that the detected object is in the backpack 2221. Because the fused image 2211 includes the data from the RGB image 2201, the fused image 2211 will also include a blurred 2213 version of the image of the individual's face.

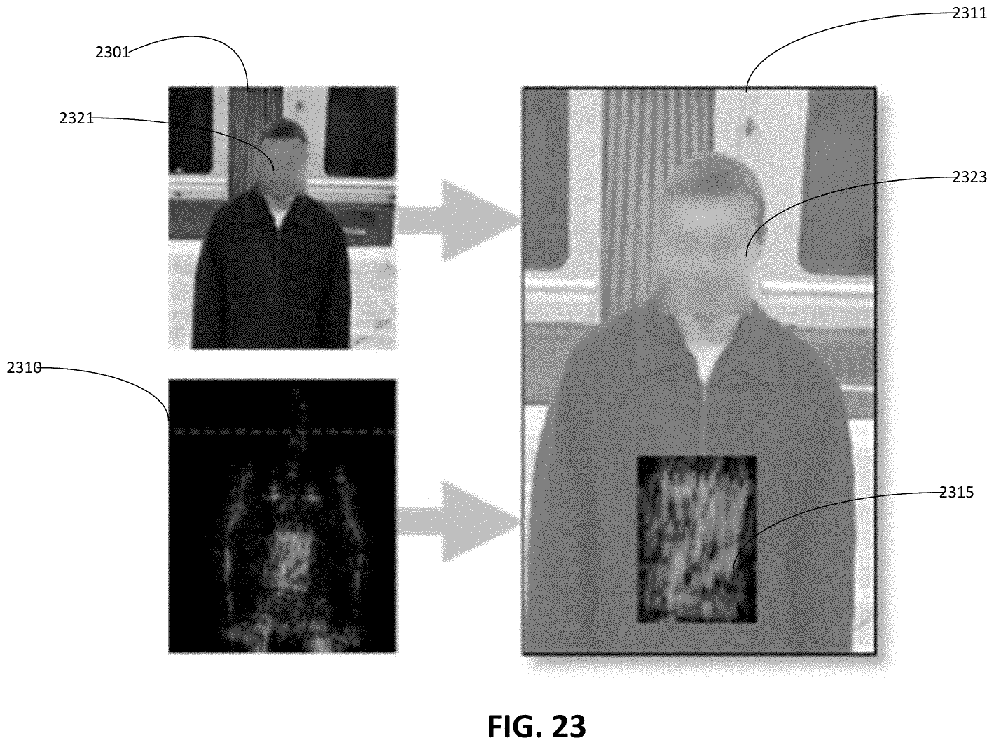

FIG. 23 illustrates a frontal view of a RF image 2310 of a scene including an individual and RGB image 2301 of the same scene. Data associated with the RGB image 2301 generated by a RGB camera, and data associated with the RF image 2310 generated by a RF sensor, are aligned and fused (the fused image 2311) to only show portions of the RF image 2310 that corresponds to a concealed anomaly 2315. The concealed anomaly 2315 corresponds to an object detected by the RF sensor, and can be seen in the RF image 2310 with the same color as the concealed anomaly 2315. Because the fused image 2311 includes the data from the RGB image 2301, the fused image 2311 will also include a blurred 2323 version of the image of the individual's face.

One or more of the processors can generate fused data by generating segmentation masks for individuals, bags, and/or other objects in the scene of a RGB image. One or more of the processors redact or blur an individual's face 2321 using a facial recognition software that is trained to detect an individual's face. One or more of the processors can then fuse the RGB image and a RF image by transforming, or aligning the RGB image into the RF image domain, through the registration process discussed above. One or more of the processors can use the segmentation masks to determine which pixels from the RF image not to redact or blur, and which pixels to redact or blur based on the RGB image.

In the case when one or more of the processors detect an anomaly, one or more of the processors can utilize detection bounding boxes and/or segmentation masks from the RF object detection architecture to determine which RF pixels in the RF image to show, and which RF images to mask in a final visualization.

Existing commercial systems that perform concealed threat detection (such as metal detectors or millimeter-wave portal scanners) generally output a binary “threat/no threat” alert and do not have much flexibility to adapt to new deployment scenarios. It can be possible to adjust sensitivity or detection thresholds, but these systems lack the ability to dynamically change—for instance, to ignore certain items or otherwise change the logic of how the system determines risk.

Embodiments of the imaging sensor system disclosed herein can be configured in such a way to classify certain objects based on a risk level scale. RF and RGB/RGB-D images can be combined by the imaging sensor system in unique ways to determine whether a person is carrying a concealed item and whether that item is considered a threat. For instance, security personnel responsible for screening fans entering a sports stadium can have different requirements or prohibited items than that of a transportation hub or museum. Embodiments of the imaging sensor systems disclosed herein can be configured to screen for different purposes to enable a dynamic security posture that can adapt to new threats in the future. More specifically, because embodiments of the imaging sensor system detect and classify objects in the scene of a RF image and RGB/RGB-D image using the machine learning algorithms, as described herein, embodiments of the imagining sensor system can be configured to learn whether a new object that has not been detected before poses a risk by importing images, either RF images or RGB/RGB-D images, that most closely resembles the detected object in the RF images or RGB/RGB-D images that are captured by the imaging sensor system. As result, the information output by the imaging sensor system can take the form of visualizations or machine-readable automated alerts.

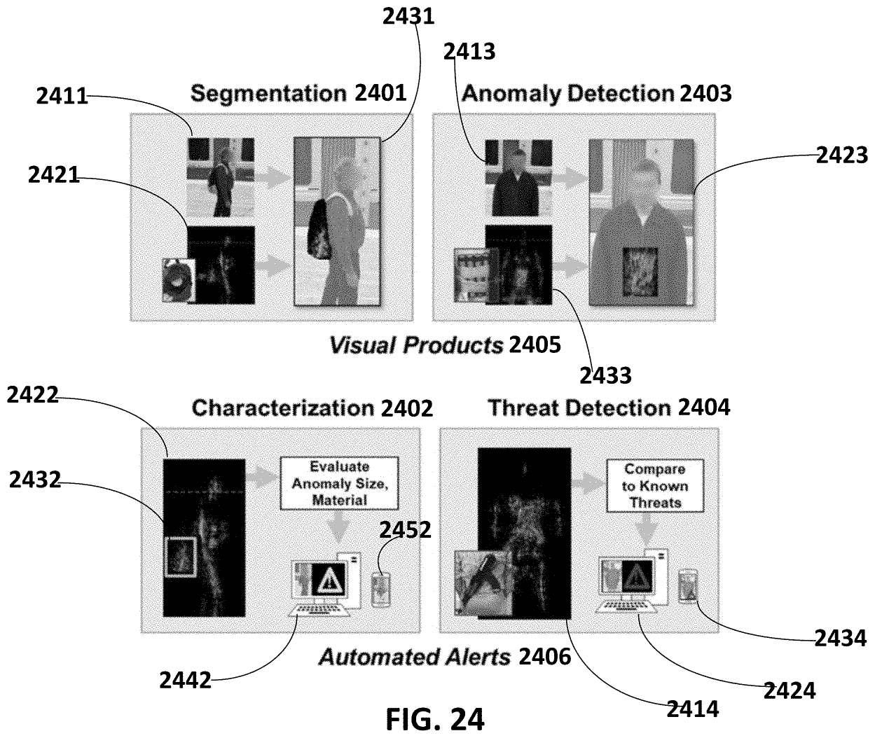

FIG. 24 illustrates different categories of output data in the form of visual or automated alerts. Visual alerts 2405 include segmentation 2401 and anomaly detection 2403. Segmentation 2401 is a visualization of a scene, or field of view, that includes the fusion of a RF image 2421 and RGB image 2411, thereby producing fused image 2431. As explained above with reference to fused image 2201 in FIG. 22, one or more of the processors can segment certain parts of the image based on objects of interest. In segmentation 2401 the backpack on the individual is segmented and a mask is generated around the backpack in the RF image and the detected object in the RF image is fused with the mask of the backpack thereby creating a fused backpack image in fused image 2431.

Anomaly detection 2403 is a visualization of a scene, or field of view, that includes the fusion of a RF image 2433 and RGB image 2413, thereby producing fused image 2423. Because the detected object in RF image 2433 is located in a region of the body where an object can be concealed and the individual is not carrying a bag on his chest or back, one or more of the processors can determine that the detected object is an anomaly and indicate that visually by displaying a visual notification on a screen to an operator of the imaging sensor system.

Automated alerts 2406 include characterization 2402 alerts and threat detection 2404 alerts. The automated alerts 2406 include a RF image 2422 and a bounding box 2432 around a detected object of interest. In this case the object is a thermos. One or more of the processors can characterize the detected object based on the size, shape, material, and/or any other parameter associated with objects, and compare the parameters to other objects with the same or similar parameters and alert an operator of the imaging sensor system about the possibility of an object that could be a potential threat. For instance, threat detection 2404 alerts include a RF image 2414, that may not have a bounding box around an object of interest. One or more of the processors detect the presence of an object of interest, and compare the size, shape, material, and/or any other parameter associated with the object and compare the size, shape, material, and/or the other parameters to other known threats and generate an automated alert notifying the operator that the individual is carrying a dangerous object.

In some embodiments the alerts can be generated on a screen of a compute such as computer 2442 or 2424, and in other embodiments the alerts can be generated on a screen of a mobile device such as mobile device 2452 or mobile device 2434.

The threat detection alerts 2404 can be generated based on one or more of the processors applying an ensemble of task-specific machine learning models to the RF image in order to determine whether an object in the scene is a threat. Task-specific machine learning models can be easier to train with limited data, and can offer improved discrimination power over conventional single black box machine learning model employed by some imagining sensor systems to identify a very large number of output classes. Black box machine learning models that are designed to identify large numbers of output classes, require millions of image examples for training, and the performance may not always be uniform across all classes. With task-specific machine learning models, the output of from each of the task-specific machine learning models can be combined to form rules-based logic, that can assist the processor(s) in identifying a potentially dangerous threat.

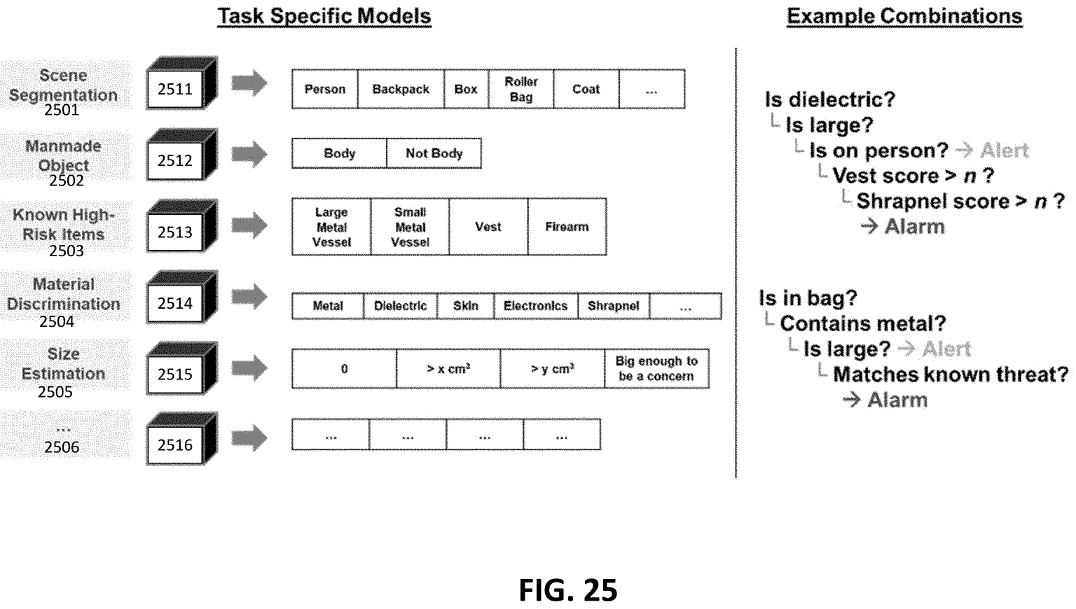

FIG. 25 illustrates task specific models and two example conditional statements that can be used by embodiments of the imaging sensor system to determine when to issue an alert and/or alarm. Each of the task-specific machine learning models can be applied to an RF image to detect, or determine something about, an object in the scene of the RF image, and the output of each of the task-specific machine learning models can be combined to determine whether a detected object is a threat. The task specific models can be implemented by one or more processors executing a RF object detection architecture instruction set that is trained to detect, or determine something about (e.g., size or material), the object in response to processing a RF image.

In some embodiments, instead of one or more of the processors just detecting a concealed object of interest, one or more of the processors can segment portions of the scene of the RF image (scene segmentation 2501) by executing one or more computer executable instructions that cause the RF object detection architecture instruction set 2511 to segment the RF image into portions that include a person, or person of interest, luggage such as a backpack or roller bag, a random item in the scene such a box, or an item of clothing such as a coat. One or more of the processors can apply a segmentation mask around each of the segmented portions of the RF image.

One or more of the processors can determine whether the object of interest is a manmade object 2502 by executing one or more computer executable instructions that cause the RF object detection architecture instruction set 2512 to learn how to discern between a manmade object and a non-manmade object. For instance, the RF object detection architecture instruction set can be trained to analyze a return RF signal from a scene, and cause One or more of the processors to determine based on the object(s) detected in the RF image that the object(s) correspond to a human body because the RF signal is reflected from human tissue, which would imply that the object(s) are non-manmade. Alternatively, the RF object detection architecture instruction set 2512 can be trained to analyze the return RF signal from the scene, and cause one or more of the processors to determine based on the object(s) detected in the RF image that the object(s) do not correspond to a human body because the RF signal is not reflected from human tissue, and therefore is either a manmade object, or another object of nature (e.g., an animal or plant).

In other embodiments, one or more of the processors can determine whether an object detected in the scene is a known-risk item 2503 by executing one or more computer executable instructions that cause the RF object detection architecture instruction set 2513 to learn how to discern between different types of high-risk items such as large metal vessels, small metal vessels, vests, and/or firearms. Yet still in other embodiments, one or more of the processors can discriminate (material discrimination 2504) between different materials that a detected object in the scene is made out of, by executing one or more computer executable instructions that cause the RF object detection architecture instruction set 2514 to learn how to discriminate between different types of materials. For instance the RF object detection architecture instruction set can contain specific instruction sets that cause one or more of the processors to discriminate between an object that is made of metal versus an object made of dielectric material, skin, electronics, and/or shrapnel. Yet still in other embodiments, one or more of the processors can also determine a size of the object (size estimation 2505) in the scene, by executing one or more computer executable instructions that cause the RF object detection architecture instruction set 2515 to learn how to estimate the size or dimensions of the object in the scene. For instance, one or more of the processors can determine that the object is a negligible size and not worth alerting a user to the presence of the object (e.g., this can correspond to the number 0), or determine that the volume of the object is greater than a certain number of cubic centimeters (e.g., greater than x cm3 or y cm3), or determine that the volume of the object exceeds a threshold that can cause one or more of the processors to generate an alert to an operator of the imaging sensor system.

Because RF object detection architecture instruction set can be trained for different purposes, several task-specific machine learning models can be run in parallel to extract complementary information (e.g., object material or size). For example, one or more processors can execute RF object detection architecture instruction set 2514 in order to discern a material about an object in the scene of a RF image, then execute the RF object detection architecture instruction set 2505 in order to estimate the size of the object, followed by the RF object detection architecture instruction set 2511 determine whether the object is on a person by segmenting portion of the scene (scene segmentation 2501). The output generated by each of these task-specific RF object detection architecture instruction sets can be applied by one or more of the processors in a logical way to determine when to alert an operator of the imaging sensor system about a potential threatening object of interest. For instance, one or more of the processors can determine that the object is a dielectric based on executing RF object detection architecture instruction set 2514, determine that the object is large based on executing RF object detection architecture instruction set 2505 to determine the size of the object, and determine that the object is on, or near, an individual based on executing RF object detection architecture instruction set 2511. In other embodiments, one or more processors identify certain characteristics of interest 2506 by executing an instruction set 2516. Based on the combination of outputs, one or more of the processors can issue an alert similar to the automated alerts described in connection with FIG. 24.

Although an alert is issued, the fact that the object is large and is dielectric does not indicate that the object is a threat. The detected object could be a common plastic item. However, if the location of the item is directly on the body in the torso region, and there is an indication that the item contains threat-like materials (e.g., shrapnel), then an alarm is issued. This can happen as a result of one or more of the processors detecting an object around the torso of an individual, and calculating a confidence level associated with the detected object being classified as a vest. One or more of the processors can determine that the object around the torso is a vest by executing the RF object detection architecture instruction set 2513, to determine if the objet around the torso falls in to one of the categories of known high-risk items 2503, which includes a vest. If one or more of the processors determines, with a certain level of confidence, that the object falls into the vest category of known high-risk items 2503, one or more of the processors can calculate a shrapnel score based on a confidence level associated with the detected object being classified as containing shrapnel. The shrapnel score can be a likelihood that the material identified in the object is more like shrapnel as opposed to another material that is found in an object that is not shrapnel. The shrapnel score can cause one or more of the processors to issue an alarm.

In another example, one or more of the processors execute the RF object detection architecture instruction set 2511, and detect a bag in a RGB image and detect a metal objet in a corresponding RF image by executing the RF object detection architecture instruction set 2514. One or more of the processors can then execute the RF object detection architecture instruction set 2515 to determine a size of the metal object, and if the size of the metal object exceeds a certain size with a certain confidence level, one or more processors execute the RF object detection architecture instruction set 2513 to determine whether it falls into a category of known high-risk items 2513. If one or more of the processors determine that it does fall into one of the categories, one or more of the processors can issue an alarm.

End users in different security scenarios can customize this logic based on their needs. In some settings, the system can be used to cue physical inspection of bags based on the sizes or materials inside. In other settings it can be more important to screen for an object of a specific shape.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components, operations, or method steps, those elements, components, operations, or steps can be replaced with a single element, component, operation, or step. Likewise, a single element, component, operation, or step can be replaced with a plurality of elements, components, operations, or steps that serve the same purpose. Moreover, while exemplary embodiments have been shown and described with references to particular embodiments thereof, those of ordinary skill in the art will understand that various substitutions and alterations in form and detail can be made therein without departing from the scope of the present disclosure. Further still, other aspects, functions and advantages are also within the scope of the present disclosure.

1. An imaging sensor system comprising:
a panel array, configured to:
transmit one or more first RF signals toward an object; and
receive one or more second RF signals, associated with the one or more transmitted RF signals, that have been reflected from the object;
one or more cameras, configured to capture one or more images of the object; and
a processor configured to execute one or more computer executable instructions, stored on a non-transitory computer readable medium, that cause the processor to:
determine a plurality of first feature maps corresponding to a RF image associated with the one or more second RF signals;
combine the plurality of first feature maps; and
detect a representation of the object in the RF image based at least in part on the combined plurality of first feature maps.

2. The system of claim 1, wherein the processor is further configured to:
detect a representation of an individual in the RF image based at least in part on a combination of a plurality of second feature maps corresponding to the RF image associated with the one or more second RF signals.

3. The system of claim 1, wherein the processor is further configured to:
determine the plurality of first feature maps that correspond to the RF image based at least in part on applying one or more first convolutional filters to the RF image.

4. The system of claim 1, wherein the RF image comprises a real and imaginary component, or a magnitude and phase component.

5. The system of claim 4, wherein one or more of the first plurality of feature maps is determined based at least in part on the real and imaginary component, or the magnitude and phase component of the RF image.

6. The system of claim 1, wherein the processor is further configured to:
combine the plurality of first feature maps based at least in part on applying one or more second convolutional filters to the RF image.

7. The system of claim 1, wherein the processor is further configured to:
determine the first plurality of feature maps based at least in part on inputting the RF image to a convolutional neural network comprising one or more stages, and wherein each of the one or stage comprises a plurality of convolutional neural network layers.

8. The system of claim 1, wherein the one or more cameras are at least one of red, green, blue (RGB) cameras, or red, green, blue depth (RGB-D) cameras.

9. A non-transitory computer-readable medium storing computer-executable instructions therein, which when executed by at least one processor, cause the at least one processor to perform the operations of:
determine a plurality of first feature maps corresponding to a RF image associated with the one or more first RF signals reflected from an object, wherein the one or more first RF signals are associated with the one or more second RF signals that have been transmitted toward the object;
combine the plurality of first feature maps; and
detect a representation of the object in the RF image based at least in part on the combined plurality of first feature maps.

10. The non-transitory computer-readable medium of claim 9, wherein the instructions stored therein further cause the at least one processor to:
detect a representation of an individual in the RF image based at least in part on a combination of a plurality of second feature maps corresponding to the RF image associated with the one or more second RF signals.

11. The non-transitory computer-readable medium of claim 9, wherein the instructions stored therein further cause the at least one processor to:
determine the plurality of first feature maps that correspond to the RF image based at least in part on applying one or more first convolutional filters to the RF image.

12. The non-transitory computer-readable medium of claim 9, wherein the RF image comprises a real and imaginary component, or a magnitude and phase component.

13. The non-transitory computer-readable medium of claim 12, wherein one or more of the first plurality of feature maps is determined based at least in part on the real and imaginary component, or the magnitude and phase component of the RF image.

14. The non-transitory computer-readable medium of claim 9, wherein the instructions stored therein further cause the at least one processor to:
combine the plurality of first feature maps based at least in part on applying one or more second convolutional filters to the RF image.

15. The non-transitory computer-readable medium of claim 9, wherein the instructions stored therein further cause the at least one processor to:
determine the first plurality of feature maps based at least in part on inputting the RF image to a convolutional neural network comprising one or more stages, and wherein each of the one or stage comprises a plurality of convolutional neural network layers.

16. A method of determining a representation of an object in the RF image, the method comprising:
determining a plurality of first feature maps corresponding to a RF image associated with the one or more first RF signals reflected from an object, wherein the one or more first RF signals are associated with the one or more second RF signals that have been transmitted toward the object;
combining the plurality of first feature maps; and
detecting a representation of the object in the RF image based at least in part on the combined plurality of first feature maps.

17. The method of claim 16, wherein the method further comprises:
detecting a representation of an individual in the RF image based at least in part on a combination of a plurality of second feature maps corresponding to the RF image associated with the one or more second RF signals.

18. The method of claim 16, wherein the method further comprising:
determining the plurality of first feature maps that correspond to the RF image based at least in part on applying one or more first convolutional filters to the RF image.

19. The method of claim 16, wherein the RF image comprises a real and imaginary component, or a magnitude and phase component.

20. The method of claim 19, wherein one or more of the first plurality of feature maps is determined based at least in part on the real and imaginary component, or the magnitude and phase component of the RF image.
